(19) United States
(12) Patent Application Publication
(10) Pub. No.: US 2026/0332192 A1
(43) Pub. Date: Oct. 22, 2026

(54) MULTI-LAYER PRECODING WITH NON-UNIFORM CONSTELLATIONS FOR MIMO TRANSMISSION

(71) Applicant: Lenovo (United States) Inc., Morrisville, NC (US)

(72) Inventors: Venkata Srinivas Kothapalli, Aurora, IL (US); Junghoon Kim, Chicago, IL (US)

(73) Assignee: Lenovo (United States) Inc., Morrisville, NC (US)

(21) Appl. No.: 19/566,783

(22) Filed: Mar. 13, 2026

(51) Int. Cl. H04B 7/0413

(52) U.S. Cl. CPC H04B 7/0413

(57) ABSTRACT

Various aspects of the present disclosure relate to multi-layer precoding with non-uniform constellations for multiple-input multiple-output (MIMO) transmission. An apparatus, such as a wireless node, maps a first set of encoded bits to modulation symbols from a first non-uniform constellation corresponding to a first MIMO layer, and maps a second set of encoded bits to modulation symbols from a second non-uniform constellation corresponding to a second MIMO layer. The node generates a precoded symbol vector according to a multi-layer precoding scheme by pre-multiplying a symbol vector containing both sets of modulation symbols by a unitary matrix. The node transmits the precoded symbol vector to a second node over the MIMO layers. The node may additionally transmit an indication of the multi-layer precoding scheme to the second node. The second node jointly decodes the first and second sets of modulation symbols based on the indication of the multi-layer precoding scheme.

### TECHNICAL FIELD

The present disclosure relates to wireless communications, and more specifically to multi-layer transmission techniques for multiple-input multiple-output (MIMO) channels.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A first node (e.g., an NE, a base station, a UE) for wireless communication is described. The first node may be configured to, capable of, or operable to perform one or more operations as described herein. For example, the first node may be configured to, capable of, or operable to map a first set of encoded bits to a first set of modulation symbols selected from a first non-uniform constellation (NUC), the first set of encoded bits corresponding to a first MIMO layer, map a second set of encoded bits to a second set of modulation symbols selected from a second NUC, the second set of encoded bits corresponding to a second MIMO layer, generate a precoded symbol vector according to a multi-layer precoding scheme, the multi-layer precoding scheme including pre-multiplying a symbol vector by a unitary matrix, where the symbol vector includes the first set of modulation symbols and the second set of modulation symbols, and transmit, to a second node, the precoded symbol vector over at least the first MIMO layer and the second MIMO layer.

A processor (e.g., a standalone processor chipset, or a component of a first node) for wireless communication is described. The processor may be configured to, capable of, or operable to perform one or more operations as described herein. For example, the processor may be configured to, capable of, or operable to map a first set of encoded bits to a first set of modulation symbols selected from a first NUC, the first set of encoded bits corresponding to a first MIMO layer, map a second set of encoded bits to a second set of modulation symbols selected from a second NUC, the second set of encoded bits corresponding to a second MIMO layer, generate a precoded symbol vector according to a multi-layer precoding scheme, the multi-layer precoding scheme including pre-multiplying a symbol vector by a unitary matrix, where the symbol vector includes the first set of modulation symbols and the second set of modulation symbols, and transmit, to a second node, the precoded symbol vector over at least the first MIMO layer and the second MIMO layer.

A method performed or performable by a first node for wireless communication is described. The method may include mapping a first set of encoded bits to a first set of modulation symbols selected from a first NUC, the first set of encoded bits corresponding to a first MIMO layer, mapping a second set of encoded bits to a second set of modulation symbols selected from a second NUC, the second set of encoded bits corresponding to a second MIMO layer, generating a precoded symbol vector according to a multi-layer precoding scheme, the multi-layer precoding scheme including pre-multiplying a symbol vector by a unitary matrix, where the symbol vector includes the first set of modulation symbols and the second set of modulation symbols, and transmitting, to a second node, the precoded symbol vector over at least the first MIMO layer and the second MIMO layer.

In some implementations of the first node, the processor, and the method described herein, the first NUC and the second NUC share one or more common modulation symbols, and the first node, the processor, and the method may further be configured to, capable of, or operable to rotate at least one of the first NUC or the second NUC by a rotation angle such that no modulation symbol in a rotated NUC is the same as any modulation symbol in another NUC. In some implementations of the first node, the processor, and the method described herein, to rotate the at least one of the first NUC or the second NUC, the first node, the processor, and the method may further be configured to, capable of, or operable to multiply each modulation symbol in the at least one of the first NUC or the second NUC by a factor of the rotation angle. In some implementations of the first node, the processor, and the method described herein, the first node, the processor, and the method may further be configured to, capable of, or operable to select the rotation angle such that an intersection of the rotated NUC and the other NUC is an empty set.

In some implementations of the first node, the processor, and the method described herein, the first node, the processor, and the method may further be configured to, capable of, or operable to refrain from rotating at least one of the first NUC or the second NUC based on the first NUC and the second NUC each including distinct modulation symbols. In some implementations of the first node, the processor, and the method described herein, the first node, the processor, and the method may further be configured to, capable of, or operable to transmit, to the second node, an indication of the multi-layer precoding scheme prior to transmitting the precoded symbol vector. In some implementations of the first node, the processor, and the method described herein, the indication identifies one or more of the unitary matrix, an identity of at least one rotated NUC, or a rotation angle applied to the at least one rotated NUC.

In some implementations of the first node, the processor, and the method described herein, the first node, the processor, and the method may further be configured to, capable of, or operable to apply the multi-layer precoding scheme based on one or more of a channel state information (CSI) report received from the second node, an indication received from the second node or a third node, or a channel condition associated with at least one of the first MIMO layer or the second MIMO layer. In some implementations of the first node, the processor, and the method described herein, the unitary matrix is a Walsh-Hadamard matrix. In some implementations of the first node, the processor, and the method described herein, the unitary matrix has dimensions corresponding to a total quantity of MIMO layers over which the precoded symbol vector is transmitted. In some implementations of the first node, the processor, and the method described herein, the unitary matrix is pre-configured at the first node and the second node. In some implementations of the first node, the processor, and the method described herein, the first NUC and the second NUC have different modulation orders. In some implementations of the first node, the processor, and the method described herein, a MIMO channel between the first node and the second node is a near-field line-of-sight MIMO channel.

A second node (e.g., an NE, a base station, a UE) for wireless communication is described. The second node may be configured to, capable of, or operable to perform one or more operations as described herein. For example, the second node may be configured to, capable of, or operable to receive, from a first node, an indication of a multi-layer precoding scheme, the multi-layer precoding scheme associated with transmission over at least a first MIMO layer and a second MIMO layer, where the multi-layer precoding scheme includes pre-multiplication of a symbol vector by a unitary matrix, and where the symbol vector includes a first set of modulation symbols selected from a first NUC and a second set of modulation symbols selected from a second NUC, receive, from the first node, a precoded symbol vector over at least the first MIMO layer and the second MIMO layer, the precoded symbol vector generated according to the multi-layer precoding scheme, and jointly decode the first set of modulation symbols and the second set of modulation symbols based on the indication of the multi-layer precoding scheme.

A processor (e.g., a standalone processor chipset, or a component of a second node) for wireless communication is described. The processor may be configured to, capable of, or operable to perform one or more operations as described herein. For example, the processor may be configured to, capable of, or operable to receive, from a first node, an indication of a multi-layer precoding scheme, the multi-layer precoding scheme associated with transmission over at least a first MIMO layer and a second MIMO layer, where the multi-layer precoding scheme includes pre-multiplication of a symbol vector by a unitary matrix, and where the symbol vector includes a first set of modulation symbols selected from a first NUC and a second set of modulation symbols selected from a second NUC, receive, from the first node, a precoded symbol vector over at least the first MIMO layer and the second MIMO layer, the precoded symbol vector generated according to the multi-layer precoding scheme, and jointly decode the first set of modulation symbols and the second set of modulation symbols based on the indication of the multi-layer precoding scheme.

A method performed or performable by a second node for wireless communication is described. The method may include receiving, from a first node, an indication of a multi-layer precoding scheme, the multi-layer precoding scheme associated with transmission over at least a first MIMO layer and a second MIMO layer, where the multi-layer precoding scheme includes pre-multiplication of a symbol vector by a unitary matrix, and where the symbol vector includes a first set of modulation symbols selected from a first NUC and a second set of modulation symbols selected from a second NUC, receiving, from the first node, a precoded symbol vector over at least the first MIMO layer and the second MIMO layer, the precoded symbol vector generated according to the multi-layer precoding scheme, and jointly decoding the first set of modulation symbols and the second set of modulation symbols based on the indication of the multi-layer precoding scheme.

In some implementations of the second node, the processor, and the method described herein, the indication further identifies one or more of the unitary matrix, an identity of at least one rotated NUC, or a rotation angle associated with the at least one rotated NUC. In some implementations of the second node, the processor, and the method described herein, jointly decoding the first set of modulation symbols and the second set of modulation symbols includes decoding with respect to the unitary matrix and the first NUC and the second NUC. In some implementations of the second node, the processor, and the method described herein, jointly decoding the first set of modulation symbols and the second set of modulation symbols includes decoding with respect to at least one rotated NUC among the first NUC and the second NUC. In some implementations of the second node, the processor, and the method described herein, the unitary matrix is a Walsh-Hadamard matrix having dimensions corresponding to a total quantity of MIMO layers over which the precoded symbol vector is received.

### BRIEF DESCRIPTION OF THE DRAWINGS

FIG. 1 illustrates an example of a wireless communications system in accordance with aspects of the present disclosure.

FIG. 2 illustrates an example of constellation arrangements, in accordance with aspects of the present disclosure.

FIG. 3 illustrates an example signaling diagram, in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of an NE in accordance with aspects of the present disclosure.

FIG. 7 illustrates a flowchart of a method performed by a first wireless node in accordance with aspects of the present disclosure.

FIG. 8 illustrates a flowchart of a method performed by a second wireless node in accordance with aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A wireless communications system may support MIMO communications that enable transmission of multiple data streams between a transmitting node and a receiving node. In a MIMO system, a transmitting node (e.g., a UE, an NE) equipped with multiple transmit antennas may communicate with a receiving node (e.g., a UE, an NE) equipped with multiple receive antennas over a channel (i.e., a MIMO channel), which may be represented by a channel matrix. The channel matrix may be decomposed using singular value decomposition (SVD) to identify eigen-channels (also referred to as eigen-modes or layers) over which data streams may be transmitted. Each eigen-channel corresponds to a singular value of the channel matrix, where the singular values indicate the channel gains of the respective eigen-channels. In a rank-n MIMO channel, up to n data streams may be transmitted simultaneously, with each data stream transmitted over a corresponding layer. Eigen-beamforming (also referred to as SVD precoding) involves precoding a symbol vector with a matrix of right singular vectors at the transmitter and applying a matrix of left singular vectors at the receiver to decompose the MIMO channel into parallel single-input single-output (SISO) channels.

In MIMO channels, the singular values corresponding to different layers may have varying magnitudes, resulting in different eigen-channels having different channel gains. A larger singular value corresponds to a higher channel gain, and the first singular value is typically larger than subsequent singular values. This disparity in channel gains causes data transmitted over weaker layers to experience higher error rates (e.g., higher bit error rate (BER) or block error rate (BLER)) compared to data transmitted over stronger layers. The problem of weaker layers is more pronounced in near-field MIMO channels operating under line-of-sight (LoS) conditions, such as when antenna array dimensions are large relative to the distance between the transmitter and receiver. In multi-path propagation environments, scattering and reflections may distribute energy more evenly across eigen-channels, resulting in a smaller disparity between singular values. However, in the near-field LoS regime, the absence of multi-path propagation means that only the first or first few singular values may have significant magnitudes while the remaining singular values are substantially smaller. The resulting disparity may be considerably larger than in multi-path environments, making weaker layers unreliable for data transmission and limiting the spatial multiplexing gain that can be achieved over the MIMO channel.

Additionally, or alternatively, the wireless communications system may support NUCs designed through geometric shaping to improve spectral efficiency and reliability, e.g., compared to conventional uniform quadrature amplitude modulation (QAM) or phase shift keying (PSK) constellations. Geometric shaping involves modifying the positions of constellation points on the in-phase and quadrature (I-Q) plane to reduce the gap to channel capacity. One-dimensional NUCs (1D-NUCs) modify constellation geometry along one axis, while two-dimensional NUCs (2D-NUCs) modify constellation geometry along both axes. While NUCs may improve performance of individual layers, the relative performance difference between stronger and weaker MIMO layers persists when NUCs are employed.

Existing methods for improving performance of weaker MIMO layers include forward error control (FEC) coding (also known as error control coding) across data transmitted over different layers. Error control coding, along with interleaving, across bits transmitted over different layers may protect, to some extent, the bits transmitted over the weaker layers. However, error control coding introduces redundant bits, demanding additional transmission resources such as transmit power, time, bandwidth, and signal processing complexity. Further, existing methods for improving the performance of weaker MIMO layers have focused on uniform QAM/PSK constellations rather than NUCs.

Accordingly, the techniques described herein provide a multi-layer precoding scheme that improves reliability of data transmission over weaker MIMO layers without introducing redundancy and without demanding additional transmission resources. The multi-layer precoding scheme combines unitary precoding with NUC rotation to couple (or entangle) modulation symbols transmitted over multiple layers. By pre-multiplying a symbol vector by a unitary matrix, such as a Walsh-Hadamard matrix, each element of the resulting precoded symbol vector is a combination of modulation symbols from multiple layers. This coupling spreads the information carried by each layer across all layers, enabling weaker layers to benefit from the channel gains of stronger layers and thereby improving the reliability of modulation symbols transmitted over the weaker layers.

As described herein, a first node may map encoded bits corresponding to different MIMO layers to modulation symbols selected from respective NUCs. When the NUCs share one or more common modulation symbols, the first node may rotate at least one of the constellations by a rotation angle such that no modulation symbol in a rotated constellation is the same as any modulation symbol in another constellation. The first node generates a precoded symbol vector by pre-multiplying a symbol vector containing the modulation symbols by a unitary matrix, such as a Walsh-Hadamard matrix. The unitary matrix couples the modulation symbols across the MIMO layers, such that each element of the precoded symbol vector is a combination of modulation symbols from multiple layers. The first node transmits an indication of the multi-layer precoding scheme to a second node, which may identify the unitary matrix, an identity of at least one rotated NUC, and/or a rotation angle applied to at least one rotated NUC. The first node transmits the precoded symbol vector over the MIMO layers to the second node. Based on the indication, the second node jointly decodes the modulation symbols received over the multiple layers with respect to the same constellations employed at the first node, including any rotation applied. In some examples, the first node applies the multi-layer precoding scheme when a channel condition, such as a difference in channel quality between a stronger MIMO layer and a weaker MIMO layer, indicates that the weaker layer would benefit from the coupling of information across layers.

The described techniques provide improvements in reliability of data transmission over multiple MIMO layers by reducing error rates without adding redundant bits or consuming additional communication resources. By coupling modulation symbols from different layers, each precoded symbol transmitted over a layer carries information from both stronger and weaker layers, enabling the weaker layers to benefit from the channel gain of the stronger layers. Moreover, combining unitary precoding with NUC constellation rotation enables increased reliability of the weaker layers by spreading the information across all of the layers. Additionally, constellation rotation ensures that constellations used on different layers do not share common modulation symbols, which facilitates joint decoding at a receiving node. The techniques described herein are particularly beneficial for near-field LoS MIMO channels where only the first or first few layers have good channel quality, enabling spatial multiplexing gain that would otherwise be impractical due to the unreliability of weaker layers.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings, is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

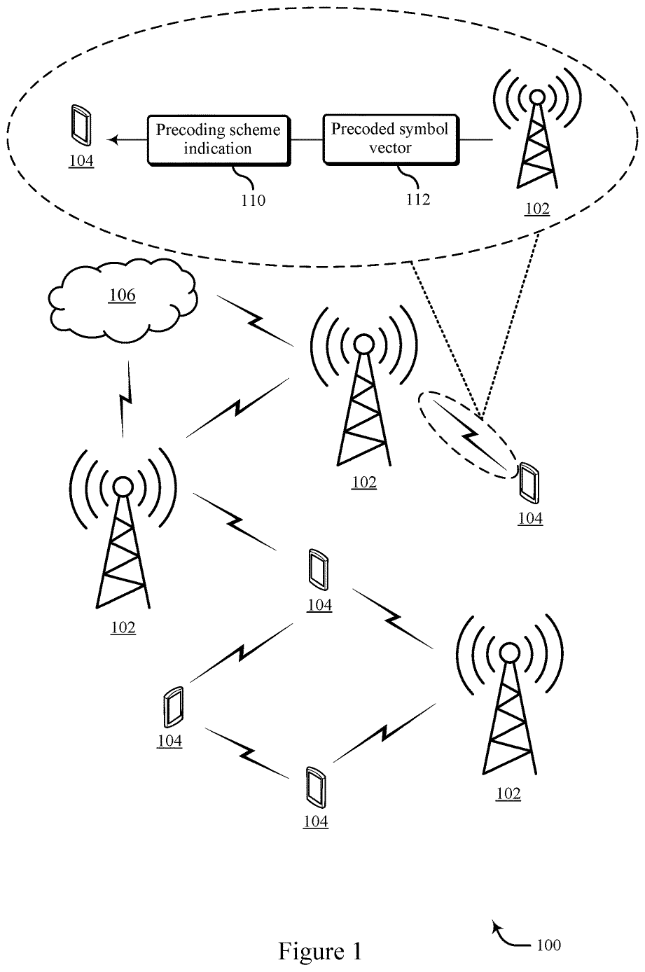

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a NE, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NEs 102. be associated with different NEs 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one 102 may interface with other NEs 102 or the CN 106 through one or more backhaul links (e.g., S1, N2, N6, or other network interface). In some implementations, the NEs 102 may communicate with each other directly. In some other implementations, the NEs 102 may communicate with each other indirectly (e.g., via the CN 106). In some implementations, one or more NEs 102 may include subcomponents, such as an access NE, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a NE 102 may be configured in a disaggregated architecture, which may be configured to utilize a protocol stack physically or logically distributed among two or more NEs 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a NE 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the NEs 102 in a disaggregated RAN architecture may be co-located, or one or more components of the NEs 102 may be located in distributed locations (e.g., separate physical locations). In some implementations, one or more NEs 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective NEs 102 that are in communication via such communication links.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support MIMO communication between two or more nodes. As used herein, a “node” refers to a device capable of wireless communication, such as a network node, network equipment, an NE 102, a UE 104, or the like, among other examples. For example, an NE 102 and a UE 104 may be capable of MIMO communications. The NE 102 may be equipped with t transmit antennas and the UE 104 may be equipped with r receive antennas. A wireless channel between the NE 102 and the UE 104 may have a total of r×t paths. In a downlink communication, where the NE 102 transmits information to the UE 104, the discrete-time channel may be represented as an r×t dimensional complex-valued channel matrix H, where element hᵢⱼ of H denotes the complex-valued channel gain between the i-th receive antenna and the j-th transmit antenna, for 1≤i≤r and 1≤j≤t. It is to be understood that, although examples described herein refer to an NE 102 and a UE 104, any node or type of node may perform the described techniques, and the examples are not to be construed as limiting.

The wireless channel gains, or the channel matrix H, may depend on the physical propagation medium. For example, due to the dynamic nature of the physical propagation medium, the wireless channel may be a time-varying channel. In some cases, these channel gains may also depend on the frequency of operation. For instance, with a multicarrier waveform, such as orthogonal frequency-division multiplexing (OFDM), the channel matrix may assume different values at different subcarriers (i.e., frequencies) at the same instant of time. In other words, the wireless channel matrix H may be stochastic in nature, varying across time, frequency, and spatial dimensions. By adapting the transmission method according to the channel realization and/or pre-processing the information signal to be transmitted according to the current channel realization, improved throughput and reliability may be achieved over a communication link. Achieving such adaptive transmission and/or implementing pre-processing at a transmitter may rely on channel state information (CSI) available at the transmitter. This may involve the transmitter knowing the channel matrix H over a frequency range of operation (e.g., at every subcarrier, such as in the case of OFDM/multi-carrier waveforms) each time the channel changes.

A receiver (e.g., the UE 104) may estimate the channel through reference or pilot signals transmitted by the transmitter (e.g., the NE 102). In some examples, the transmitter acquires channel knowledge via the receiver feeding back CSI estimated (by the receiver) based on the reference or pilot signals received from the transmitter. For example, in a downlink communication from the NE 102 to the UE 104, the UE 104 may estimate the downlink CSI (e.g., the channel matrix, or the channel covariance matrix) using pilot or reference signals transmitted by the NE 102, and the UE 104 may transmit the estimated CSI back to the NE 102. The CSI feedback from the UE 104 to the NE 102 may include one or more of the channel matrix, the channel covariance matrix, right singular vectors of the channel matrix, eigen vectors of the channel, or a combination of a rank indicator (RI), a precoder matrix indicator (PMI), and a channel quality indicator (CQI) derived from the estimated CSI. Similarly, in an uplink communication from the UE 104 to the NE 102, the NE 102 may estimate the CSI based on uplink reference or pilot signals from the UE 104 and may feed back the CSI to the UE 104. In any case, once channel knowledge is available at the transmitter, the signal to be transmitted may be pre-processed in accordance with the known channel. This pre-processing of the transmitted signal in accordance with the wireless channel is commonly referred to as “precoding” or “beamforming.”

A method of precoding or beamforming is eigen-beamforming, which involves transmitting multiple data streams along the multiple eigen-modes of the MIMO channel. Eigen-beamforming decomposes the MIMO channel into n SISO (single-input single-output) eigen-channels, where n is the rank of the MIMO channel matrix H. The gain of an i-th eigen-channel is equal to the i-th singular value of the channel matrix H. Singular values of a channel matrix may have varying magnitudes, resulting in different eigen-channels having different gains. SVD produces ordered singular values, such that the first singular value has a higher magnitude than the second singular value, the second singular value has a higher magnitude than the third singular value, and so on. More formally, let σᵢ≥0, for 1≤i≤n, denote the singular values of H. Then σ₁≥σ₂≥ . . . ≥σₙ≥0, where n=min(r, t) is the maximum possible rank of H. Thus, symbols transmitted over the first eigen-channel may enjoy a higher channel gain than the symbols transmitted over the second eigen-channel, and so on. In some cases, some singular values may be considerably low, resulting in a large number of errors in the symbols or data transmitted over the corresponding eigen-channels. This problem may become more severe in the case of near-field MIMO channels.

The rank of a channel matrix H is equal to the number of its non-zero singular values. In principle, a rank-n MIMO channel H may allow transmission of n message symbols per channel use (or, equivalently, n data streams or symbol streams). Each eigen-channel may also be referred to as a “layer,” and a rank-n MIMO channel H may enable simultaneous transmission of n message symbols (or, equivalently, n symbol streams) over the n layers. When k≤n symbols are transmitted simultaneously (i.e., per channel use) over k eigen-channels, this is commonly referred to as k-layer transmission.

The presence of reflectors in the physical propagation medium, the number of paths between the transmitter and the receiver, and other characteristics of the channel may determine the channel rank and the magnitude of the singular values of a MIMO channel. In the far-field regime, if there is only a direct path between each transmitting antenna and each receive antenna, resulting in an LoS component with no multi-path propagation between the transmitter and the receiver, then the channel matrix may be rank deficient. In such a case, the channel matrix may have only unit rank with only one non-zero singular value, allowing transmission of only one symbol stream.

In the near-field regime, even when there is only LoS with no multi-path propagation, the channel matrix may not be rank deficient. The LoS channel matrix may have full rank, with all its singular values having non-zero values. In the case of near-field MIMO channels, however, only the first or the first few singular values may have high values, while other singular values, though non-zero, may have values that are significantly smaller than the first few singular values. Thus, though the LoS near-field MIMO channel may not be rank deficient, the channel matrix may have a considerably higher condition number, defined as the ratio of the maximum singular value to the minimum singular value. The layers, eigen-channels, or eigen-modes corresponding to lower values of singular values may not be reliable for transmitting symbol streams, as they may result in high symbol or bit errors.

Although the near-field MIMO channel under LoS conditions may not be rank deficient like a LoS far-field MIMO channel, many of the layers, eigen-channels, or eigen-modes may not be reliable for data transmission. By improving the reliability over such weaker layers, eigen-channels, or eigen-modes, spatial multiplexing gain may be realized and a considerable increase in data throughput per channel use may be achieved. The following describes the SVD of the channel matrix and the eigen-beamforming procedure in further detail.

The following notation is used throughout the present disclosure. For a matrix Z∈ [symbol] ^{r×t}, zᵢⱼ, Z_{i,1:t}, and Z_{1:r,j} denote the (i, j)^{th} element, i^{th} row, and j^{th} column of matrix Z, respectively. A block of matrix Z consisting of elements in row i to i′ and column j to j′ and is denoted by Z_{i:i′,j:j′}. The superscript T denotes the transpose of a vector or a matrix, and the superscript * denotes the conjugate transpose (also known as Hermitian transpose) of a vector or a matrix. Thus, for a vector a, a^{T} denotes transpose of a, and a* denotes conjugate transpose (Hermitian) of a. The same notation hods true for a matrix A. The identity matrix of dimension r×r is denoted by I_{r×r}.

The SVD of the channel matrix H∈ [symbol] ^{r×t} is given by SVD(H)=UΣV*, where U∈ [symbol] ^{r×r} and V∈ [symbol] ^{t×t} are unitary matrices comprising left and right singular vectors, respectively, of H, and Σ∈ [symbol] _{≥0}^{r×t} is a diagonal matrix where Σᵢⱼ=σᵢ, for 1≤i≤n, are the singular values of H, with σ₁≥σ₂≥ . . . ≥σₙ≥0 and n=min(r, t). When H is full rank, all the singular values σᵢ, for 1≤i≤n, are non-zero. When H is ill-conditioned or not of full rank, some of the singular values may be equal to zero. The SVD decomposition allows the matrix H to be expressed as the equation below:

$$H = {\sum }_{i = 1}^{n} {σ}_{i} {U}_{: , i} {V}_{: , i}^{*}$$

Because U and V are unitary matrices, UU*=I_{r×r} and VV*=I_{t×t}, which means that U* is the inverse of U and V* is the inverse of V.

Performing SVD allows a node (e.g., a transmitting node) to decompose a MIMO channel into multiple (virtual) SISO channels in order to transmit multiple data streams, one each, on the resulting (virtual) SISO channels. This method may be referred to as SVD precoding, SVD beamforming, eigen-beamforming, or eigen-channel transmission, and is performed as follows.

Assuming the channel matrix is a square matrix (such that r=t) and has full rank (i.e., all the singular values of H are non-zero), let s=[s₁, . . . , sₜ]^{T}∈ [symbol] ^{t×1} be the symbol vector to be transmitted over the t transmit antennas, where sᵢ is the symbol transmitted from the i^{th} transmit antenna and sᵢ∈ [symbol] , where [symbol] denotes a signaling constellation (such as an M-QAM, M-PSK, or the like). The symbol vector to be transmitted, s=[s₁, . . . , sₜ]^{T}∈ [symbol] ^{t×1}, is precoded with matrix V (which comprises right singular vectors) to obtain a precoded symbol vector x=Vs. The precoded symbol vector x is then transmitted over the MIMO channel H.

The discrete received symbol vector at the receiver, denoted by y∈ [symbol] ^{r×1}, may be expressed as:

y=Hx+n=H(Vs)+n=UΣV*(Vs)+n

The receiver multiplies the received symbol vector y with the Hermitian of matrix U to obtain vector z∈ [symbol] ^{r×1}, where:

z=U*y=U*H(Vs)+U*n

Because H=UΣV*, and UU*=I_{r×r}, VV*=I_{t×t}, this results in:

z=U*(UΣV*)(Vs)+U*n=Σs+ñ
where ñ=U*n. Because Σ is a diagonal matrix with diagonal entries σᵢ, this results in zᵢ=σᵢsᵢ+ñᵢ, for i=1, . . . , r. Thus, the matrix MIMO channel is decomposed into parallel SISO channels, with the gain of the i-th SISO channel given by the i-th singular value σᵢ. These parallel SISO channels are commonly referred to as the eigen-channels, or eigen-modes, of the MIMO channel H. To recover the transmitted symbols, zᵢ, for i=1, . . . , r, may be decoded using conventional decoding techniques.

In some cases, only one data stream may be transmitted, in which case only the right singular vector corresponding to the first singular value is used (in place of the V matrix) as the precoding vector at the transmitter, and the Hermitian of the left singular vector corresponding to the first singular value is used (in place of the matrix U*) at the receiver. Such a case results in single layer transmission where only one data stream is transmitted over the MIMO channel.

As an example of eigen-beamforming in the wireless communications system 100, consider a two-layer downlink transmission from the NE 102 having 4 transmit antennas to the UE 104 equipped with 2 receive antennas. With r=2 and t=4, the downlink MIMO channel matrix H is a 2×4 matrix. The SVD of H results in SVD(H)=UΣV*, where U∈ [symbol] ^{2×2} and V∈ [symbol] ^{4×4} are unitary matrices comprising left and right singular vectors, respectively, of H, and Σ∈ [symbol] _{≥0}^{2×4} has only two non-zero elements given by Σ₁₁=σ₁≥0 and Σ₂₂=σ₂≥0. There are at most two non-zero singular values because the rank of H is at most equal to 2. Assuming both singular values are non-zero, i.e., σ₁≥σ₂>0, the second singular value σ₂ typically has a considerably lower value than the first singular value σ₁.

In such a case, the transmit symbol vector is s=[s₁, s₂, 0,0]^{T}∈ [symbol] ^{4×1}, with s₁, s₂∈ [symbol] , where [symbol] is an M-QAM constellation. Symbol s₁ is intended to be transmitted over the first layer (e.g., the first eigen-channel or first eigen-mode), and symbol s₂ is to be transmitted over the second layer (e.g., the second eigen-channel or second eigen-mode). The symbol vector s is precoded with matrix V to obtain the precoded symbol vector x=Vs, and x is transmitted by the NE 102 over the MIMO channel H.

The receiver multiplies the received symbol vector y with the Hermitian of U to obtain vector z∈ [symbol] ^{2×1}, where z=U*y=U*H(Vs)+U*n. This results in z=Σs+ñ, which can be expanded as shown below:

z₁=σ₁s₁+ñ₁

z₂=σ₂s₂+ñ₂

The receiver determines the values of σ₁ and σ₂ based on knowledge of the downlink MIMO channel and decodes z₁ and z₂ to obtain estimates s₁ and s₂ of the transmitted symbols s₁ and s₂, respectively.

Even under multi-path propagation resulting in non-zero values for both σ₁ and σ₂, the value of σ₂ may be significantly smaller than the value of σ₁. This may reduce the reliability of data transmitted over the second layer (e.g., the second eigen-channel or second eigen-mode), causing a large number of errors in the data stream transmitted over the second layer. This problem may be more pronounced in the case of near-field MIMO channels under LoS conditions. In LoS conditions, a near-field MIMO channel may almost always have full rank, but the singular values other than the first singular value may have significantly lower values, making the full-rank MIMO channel impractical for two-layer or multi-layer transmission (i.e., transmitting more than one symbol per channel use). The problem of weaker layers, or weaker eigen-channels or weaker eigen-modes, may be addressed as discussed herein to exploit the spatial multiplexing gain of the underlying MIMO channel and improve the spectral efficiency of the wireless links.

Two-layer transmission is considered herein as an example. Multi-layer transmission (i.e., more than two-layer transmission) may be achieved in a similar manner. However, the problem of weaker layers, eigen-modes, or eigen-channels may become more prominent with additional layers, significantly reducing the reliability of data transmitted over the layers other than the first layer corresponding to the highest singular value.

According to implementations, one or more of the NEs 102 and the UEs 104 are operable to implement various aspects of the techniques described with reference to the present disclosure. For example, to address the problem of weaker layers in MIMO channels, the NE 102 may apply a multi-layer precoding scheme that couples modulation symbols transmitted over multiple MIMO layers. The NE 102 may map a first set of encoded bits corresponding to a first MIMO layer to a first set of modulation symbols selected from a first NUC, and map a second set of encoded bits corresponding to a second MIMO layer to a second set of modulation symbols selected from a second NUC. When the first NUC and the second NUC share one or more common modulation symbols, the NE 102 may rotate at least one of the NUCs by a rotation angle such that no modulation symbol in a rotated NUC is the same as any modulation symbol in another NUC. The NE 102 may generate a precoded symbol vector 112 according to the multi-layer precoding scheme by pre-multiplying a symbol vector, which includes the first set of modulation symbols and the second set of modulation symbols, by a unitary matrix such as a Walsh-Hadamard matrix.

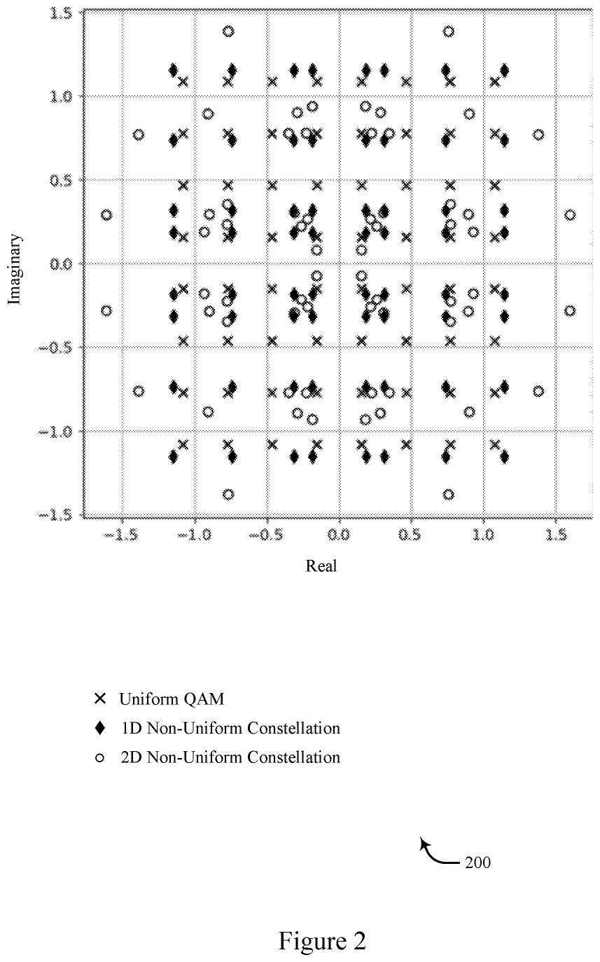

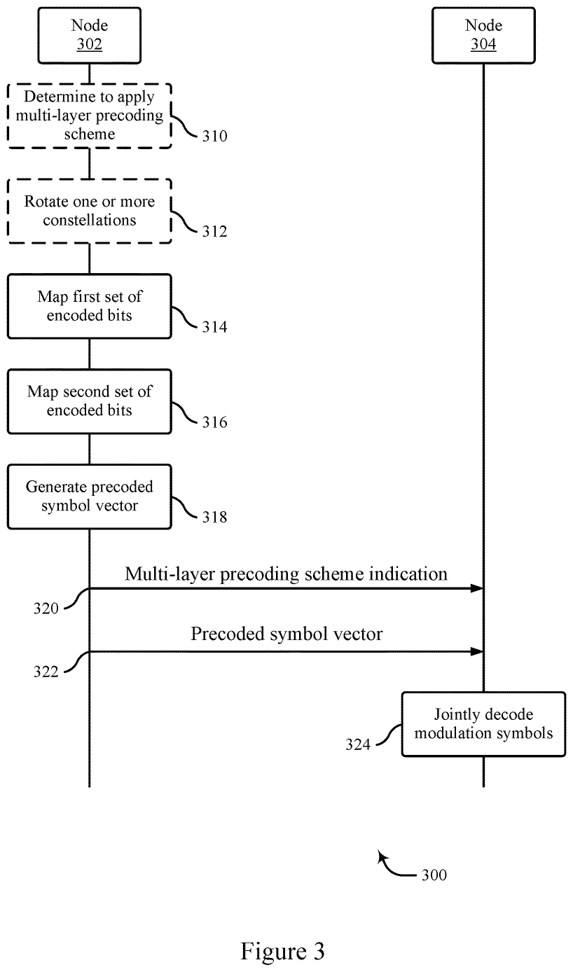

Prior to transmission of the precoded symbol vector 112, the NE 102 may transmit a precoding scheme indication 110 to the UE 104 that identifies one or more of the unitary matrix, an identity of at least one rotated NUC, or a rotation angle applied to at least one rotated NUC, thereby enabling the UE 104 to properly decode the subsequent precoded symbol vector 112. The NE 102 may transmit the precoded symbol vector 112 to the UE 104 over at least the first MIMO layer and the second MIMO layer. Based on the precoding scheme indication 110, the UE 104 may jointly decode the first set of modulation symbols and the second set of modulation symbols with respect to the unitary matrix and the NUCs, including any rotation applied. Because the modulation symbols are coupled across layers by the unitary matrix, each element of the precoded symbol vector 112 is a combination of modulation symbols from the first set of modulation symbols and the second set of modulation symbols. Joint decoding at the UE 104 may account for this coupling to recover the transmitted modulation symbols from both the stronger and weaker MIMO layers. The multi-layer precoding scheme and the constellation arrangements used for the multi-layer precoding scheme are described in further detail with reference to FIGS. 2 and 3.

FIG. 2 illustrates example constellation arrangements 200 in accordance with aspects of the present disclosure. The constellation arrangements 200 illustrate constellations for a 1D-NUC and a 2D-NUC compared with uniform QAM.

The constellation arrangements 200 are plotted on a two-dimensional plane with a real axis (horizontal) representing the in-phase (I) component and an imaginary axis (vertical) representing the quadrature (Q) component. Three constellation types are illustrated. X markers represent uniform QAM constellation points, which are arranged in a regular grid pattern with uniform spacing between adjacent points in both the horizontal and vertical directions. Filled diamond markers represent 1D-NUC points. As illustrated, the 1D-NUC points have been rotated relative to the uniform QAM points to be adjusted with respect to a single axis. The 1D-NUC points maintain alignment along one axis similar to the uniform QAM but exhibit non-uniform spacing along the other axis, with some points clustered closer together than others. Open circle markers represent 2D-NUC points, which have been rotated relative to the uniform QAM points to be adjusted with respect to both axes. The 2D-NUC points are thus distributed in a non-regular pattern across both dimensions, with varying distances between adjacent points in both the horizontal and vertical directions.

As illustrated, some constellation points of the different constellation types may overlap or be positioned near one another, indicating that different NUCs used on different MIMO layers may share one or more common modulation symbols. As described below, when NUCs share common modulation symbols, constellation rotation may be applied to ensure that no two constellations used on different layers share common modulation symbols.

The constellation arrangements 200 illustrate examples of different constellation types that may be used for modulation in wireless communication. A signal constellation is a collection of real-valued or complex-valued symbols. A signal constellation may also be referred to as a constellation or a signal set. A signal constellation may be considered as a set whose elements are modulation symbols. As used herein, the terms “signal constellation,” “symbol constellation,” “signal set,” and “constellation” are used interchangeably.

For example, a binary phase shift keying (BPSK) constellation, or BPSK signal set, comprises two modulation symbols, +1 and −1, and the constellation is denoted by [symbol] _{BPSK}={+1, −1}. A 4-QAM constellation comprises 4 modulation symbols and may be expressed as [symbol] _{4-QAM}={1+j, 1−j, −1+j, −1−j}, where j=\sqrt{−1}. An M-ary QAM, commonly referred to as M-QAM, comprises M modulation symbols. When M=2^{k}, where k is a positive integer, the constellation is referred to as a square QAM constellation because the modulation symbols, when plotted on a two-dimensional plane, form the geometric shape of a square.

Conventional uniform QAM and uniform PSK constellations may exhibit an SNR loss in spectral efficiency relative to channel capacity. The SNR loss compared to optimal Gaussian signaling over additive white Gaussian noise (AWGN) channels is approximately 1.53 dB and is referred to as the shaping loss. Shaping of signaling constellations is a strategy to improve reliability and spectral efficiency over uniform QAM and uniform PSK constellations and to reduce the gap to the theoretically achievable channel capacity. There are two types of shaping: geometric shaping (GS) and probabilistic shaping (PS).

Geometric shaping refers to modifying the positions of discrete constellation points on the in-phase and quadrature (I-Q) plane. Geometric shaping yields NUCs. Deviating from standard geometries (e.g., square and rectangular M-QAM, circular M-PSK) may improve the mutual information between the channel input and its output and the reliability of information transfer. With NUCs, the SNR gains in spectral efficiency may be up to 1 dB when compared to conventional uniform QAM constellations over AWGN channels. NUCs may, however, affect other modules or functions at the transmitter (such as peak-to-average power ratio (PAPR)) and may involve re-designing signal processing algorithms at the receiver (e.g., the log-likelihood ratio (LLR) computation module, the symbol detection module, and/or the symbol demapper).

The study of different types of constellation shaping methods may be pursued to evaluate the performance gains and associated costs of shaped constellations in improving the performance of wireless links. In some examples, 6G wireless communication systems may employ shaped constellations together with conventional uniform QAM/PSK constellations. NUCs designed through geometric shaping may offer a favorable tradeoff between complexity and performance.

A 1D-NUC refers to modifying the constellation geometry along one axis. This yields geometrically square or rectangular NUC QAM constellations. A 2D-NUC provides two degrees of freedom and allows NUC optimization in both the I and Q directions, potentially yielding non-square or non-rectangular constellations and allowing for higher gains in spectral efficiency. However, the gains with 2D-NUC may come at the cost of added complexity and reduced parallelized processing capabilities per direction, because the demapper at the receiver may treat the I and Q components jointly to perform symbol detection, demapping, and/or LLR computation.

When NUCs designed through geometric shaping are employed in place of uniform QAM/PSK constellations, the MIMO precoding operations described with reference to FIG. 1 may still be applied, though the information-bearing modulation symbols sᵢ are selected from NUCs rather than from uniform constellations. Using NUCs over different layers in a MIMO transmission may improve the performance of each MIMO layer, because when there is no inter-layer interference, transmission over each layer may be considered to be effectively the same as transmission over a SISO channel. When a shaped constellation is used over a wireless link in place of a uniform QAM/PSK constellation, a shaping gain may be achieved. Thus, performance of each MIMO layer may be improved by the shaped NUCs. However, the relative performance difference between stronger MIMO layers and weaker MIMO layers may remain the same. Whether uniform QAM/PSK constellations or NUCs designed through geometric shaping are used, the problem of weaker MIMO layers degrading the overall performance of the MIMO channel may persist.

To address this problem, the multi-layer precoding scheme described herein couples modulation symbols transmitted over multiple MIMO layers to improve the reliability of data transmission over weaker layers when NUCs are employed. The multi-layer precoding scheme described herein is based on precoding with a unitary matrix and, in some cases, rotating signal constellations. Two concepts are described below: unitary matrices and rotated constellations.

A unitary matrix is a square matrix U of size d×d, having real or complex-valued elements, that satisfies the property UU*=U*U=I_{d×d}, where I_{d×d} is the identity matrix of size d×d. If all the elements of U are real-valued, then the property may be written as UU^{T}=U^{T}U=I_{d×d}.

Unitary matrices of desired dimensions may be obtained, and there exist unitary matrices having structures that are well-suited for digital communications. Walsh-Hadamard matrices are examples of unitary matrices that may be constructed in an iterative manner. In the following description, Walsh-Hadamard matrices are discussed as an example of unitary matrices that may be used in the multi-layer precoding scheme. However, the multi-layer precoding scheme described herein may use any unitary matrix in place of Walsh-Hadamard matrices.

A Walsh-Hadamard matrix of dimension N×N, where N=2^{k} and k is a positive integer, is denoted by W_{N}. In W_{N}, columns and rows are of unit norm with entries equal to ±1/\sqrt{N}, and:

$${W}_{N}^{T} {W}_{N} = {I}_{N} = {W}_{N} {W}_{N}^{T}$$

where I_{N} denotes the identity matrix of size N×N.

A 2×2 Walsh-Hadamard matrix, denoted by W₂_{¹}, is given by:

$${W}_{{2}^{1}} = {W}_{2} = \frac{1}{\sqrt{2}} [ \begin{matrix}1 & 1 \\ 1 & - 1\end{matrix} ]$$

A 2^{k}×2^{k} Walsh-Hadamard matrix, where k is a positive integer, may be constructed based on a recursive relation as follows:

$${W}_{{2}^{k}} = [ \begin{matrix}{W}_{{2}^{k ‐ 1}} & {W}_{{2}^{k ‐ 1}} \\ {W}_{{2}^{k ‐ 1}} & - {W}_{{2}^{k ‐ 1}}\end{matrix} ]$$

For example, a 4×4 Walsh-Hadamard matrix, denoted by

$${W}_{{2}^{2}} ,$$

may be constructed from

$${W}_{{2}^{1}}$$

as follows:

$${W}_{{2}^{2}} = {W}_{4} = [ \begin{matrix}{W}_{{2}^{1}} & {W}_{{2}^{1}} \\ {W}_{{2}^{1}} & - {W}_{{2}^{1}}\end{matrix} ] = \frac{1}{\sqrt{4}} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$$

Rotating a constellation (or signal set) refers to multiplying each modulation symbol in the constellation by e^{jθ}, where 0<θ<2π. If [symbol] _{M-QAM} denotes a conventional uniform M-QAM constellation, then a rotated uniform M-QAM constellation with rotation angle θ is denoted by e^{jθ} [symbol] _{M-QAM}. Similarly, if [symbol] _{M-NUC} denotes a NUC with M points designed through geometric shaping, then a rotated M-NUC with rotation angle θ is denoted by e^{jθ} [symbol] _{M-NUC}. More generally, if [symbol] denotes a signaling constellation (either a conventional uniform constellation or a NUC), then e^{jθ} [symbol] denotes a rotated constellation [symbol] rotated by an angle θ.

As an example, consider a NUC comprising 16 modulation symbols obtained through geometric shaping of a uniform 16-QAM constellation. The 16-point NUC, or equivalently the NUC signal set comprising 16 modulation symbols, is denoted by [symbol] _{16-NUC}={a₁, a₂, . . . , a₁₆}, where aᵢ denotes the i-th complex-valued modulation symbol in the 16-NUC constellation. After rotating [symbol] _{16-NUC} by an angle θ, with

$$0 < θ < \frac{π}{2} ,$$

the rotated 16-NUC constellation is given by the following:

$${𝒮}_{16 - NUC}^{θ} = {e}^{j θ} {𝒮}_{16 - NUC} = \{ {e}^{j θ} {a}_{1} , {e}^{j θ} {a}_{2} , … , {e}^{j θ} {a}_{16} \}$$

The application of the multi-layer precoding scheme is described below using a two-layer transmission as an illustrative example.

The multi-layer precoding scheme may be applied to a two-layer transmission over a point-to-point MIMO channel H having dimensions r×t, with t transmit antennas at the transmitting node and r receive antennas at the receiving node. The symbol constellation to be used for transmission on the first MIMO layer may be a first NUC comprising M₁ modulation symbols (also referred to as constellation points), denoted by

$${𝒮}_{{M}_{1} - NUC}^{{L}_{1}} .$$

The symbol constellation to be used for transmission on the second MIMO layer may be a second NUC, denoted by

$${𝒮}_{{M}_{2} - NUC}^{{L}_{2}} ,$$

comprising M₂ modulation symbols.

The modulation orders M₁ and M₂ may be equal or may have different values. When M₁=M₂, the modulation order is the same on both layers. When M₁≠M₂, the first MIMO layer has a different modulation order than the second MIMO layer. For example, the first NUC may have a modulation order of 64 and the second NUC may have a modulation order of 16.

As described above, a signal constellation may be considered as a set whose elements are modulation symbols. When

$${𝒮}_{{M}_{1} - NUC}^{{L}_{1}} {∩𝒮}_{{M}_{2} - NUC}^{{L}_{2}} = ∅ ,$$

where Ø indicates an empty set, the constellations

$${𝒮}_{{M}_{1} - NUC}^{{L}_{1}} and {𝒮}_{{M}_{2} - NUC}^{{L}_{2}}$$

do not contain any common modulation symbols; that is, every modulation symbol in

$${𝒮}_{{M}_{{1}^{-}} N U C}^{{L}_{1}}$$

is different from every modulation symbol in

$${𝒮}_{{M}_{2} - NUC}^{{L}_{2}}$$

(e.g., each constellation comprises distinct modulation symbols). The case

$${𝒮}_{{M}_{1} - N U C}^{{L}_{1}} ⋂ {𝒮}_{{M}_{2} - N U C}^{{L}_{2}} \neq ∅$$

corresponds to the situation when one or more modulation symbols in

$${𝒮}_{{M}_{{1}^{-}} N U C}^{{L}_{1}}$$

are the same as one or more modulation symbols in

$${𝒮}_{{M}_{{2}^{-}} N U C}^{{L}_{2}} .$$

Let s₁ and s₂ be the modulation symbols to be transmitted over the first MIMO layer and the second MIMO layer, respectively, and let s=[s₁s₂]^{T} denote the symbol vector to be transmitted. When

$${𝒮}_{{M}_{{1}^{-}} N U C}^{{L}_{1}} = {𝒮}_{{M}_{2} - N U C}^{{L}_{2}} , or when {𝒮}_{{M}_{{1}^{-}} N U C}^{{L}_{1}} ⋂ {𝒮}_{{M}_{{2}^{-}} N U C}^{{L}_{2}} \neq ∅$$

(i.e., when the first NUC and the second NUC share one or more common modulation symbols), the following operations may be performed at the transmitter.

The transmitter may maintain the first NUC

$${𝒮}_{{M}_{{1}^{-}} N U C}^{{L}_{1}}$$

intact, e.g., may retrain from rotating the first NUC. Modulation symbols to be transmitted over the first MIMO layer may be selected from the constellation

$${𝒮}_{{M}_{{1}^{-}} N U C}^{{L}_{1}} .$$

The transmitter may rotate the second

$${e}^{j θ} {𝒮}_{{M}_{{2}^{-}} N U C}^{{L}_{2}} .$$

by a rotation angle θ to obtain a rotated constellation

$$NUC {𝒮}_{{M}_{{2}^{-}} N U C}^{{L}_{2}}$$

Modulation symbols to be transmitted over the second MIMO layer may be selected by the transmitter from the rotated constellation

$${e}^{j θ} {𝒮}_{{M}_{{2}^{-}} NUC}^{{L}_{2}} .$$

The transmitter may select the rotation angle θ such that every modulation symbol in the rotated constellation

$${e}^{j θ} {𝒮}_{{M}_{2} - N U C}^{{L}_{2}}$$

is different from every modulation symbol in

$${𝒮}_{{M}_{1} - N U C}^{{L}_{1}} .$$

In other words, if the constellations

$${𝒮}_{{M}_{{1}^{-}} N U C}^{{L}_{1}}$$

and

$${e}^{j θ} {𝒮}_{{M}_{2} - NUC}^{{L}_{2}}$$

are treated as sets, the intersection between the set of modulation symbols

$${𝒮}_{{M}_{{1}^{-}} N U C}^{{L}_{1}}$$

and the set of modulation symbols

$${e}^{j θ} {𝒮}_{{M}_{2} - NUC}^{{L}_{2}}$$

may be an empty set. That is, the transmitter may select the rotation angle such that the constellations

$${𝒮}_{{M}_{1} - NUC}^{{L}_{1}}$$

and

$${e}^{j θ} {𝒮}_{{M}_{2} - NUC}^{{L}_{2}}$$

may not have any common modulation symbols, as illustrated by the equation below.

$${𝒮}_{{M}_{1} - NUC}^{{L}_{1}} ∩ {e}^{j θ} {𝒮}_{{M}_{2} - NUC}^{{L}_{2}} = ∅$$

In some examples, instead of keeping the first NUC S_{M1-NUC}^{L1} intact and rotating the second

$$NUC {𝒮}_{{M}_{2} - NUC}^{{L}_{2}} ,$$

the first

$$NUC {𝒮}_{{M}_{1} - NUC}^{{L}_{1}}$$

may be rotated by an angle θ to obtain

$${e}^{j θ} {𝒮}_{{M}_{1} - NUC}^{{L}_{1}} ,$$

while the second

$$NUC {𝒮}_{{M}_{2} - NUC}^{{L}_{2}}$$

is kept intact. The rotation of

$${𝒮}_{{M}_{1} - NUC}^{{L}_{1}}$$

may be performed such that the constellations

$${e}^{j θ} {𝒮}_{{M}_{1} - NUC}^{{L}_{1}} and {𝒮}_{{M}_{2} - NUC}^{{L}_{2}}$$

do not comprise any common modulation symbols, i.e., the rotation angle may be selected by the transmitter such that:

$${e}^{j θ} {𝒮}_{{M}_{1} - NUC}^{{L}_{1}} {∩𝒮}_{{M}_{2} - NUC}^{{L}_{2}} = ∅$$

The transmitter may select the modulation symbol s₁ from the constellation

$${𝒮}_{{M}_{1} - NUC}^{{L}_{1}}$$

and the modulation symbol s₂ from the rotated constellation

$${e}^{j θ} {𝒮}_{{M}_{2} - NUC}^{{L}_{2}} .$$

The symbol vector s=[s₁s₂]^{T}, comprising the modulation symbols to be transmitted on the first MIMO layer and the second MIMO layer, where s₁∈

$${𝒮}_{{M}_{1} - NUC}^{{L}_{1}} and {s}_{2} ∈ {e}^{j θ} {𝒮}_{{M}_{2} - NUC ,}^{{L}_{2}}$$

may be pre-multiplied by a 2×2 Walsh-Hadamard matrix W₂ to obtain a precoded symbol vector x=[x₁x₂]^{T}, where x=W₂s. The transmitter transmits the precoded modulation symbol x₁ over the first MIMO layer and the precoded modulation symbol x₂ over the second MIMO layer.

When x₁ and x₂ are transmitted over the first MIMO layer and the second MIMO layer, respectively, the received symbols at the receiver are given by:

z₁=σ₁z₁+n₁

z₂=σ₂z₂+n₂
where σ₁ and σ₂ are the first and the second singular values, respectively, of the MIMO channel. Upon receiving the precoded symbols transmitted by the transmitter, the receiver jointly decodes the modulation symbols received on both layers with respect to the constellations used at the transmitter. The receiver obtains estimates of the transmitted modulation symbols s₁ and s₂, denoted by ŝ₁ and ŝ₂, respectively, by:

$${\hat{s}}_{1} , {\hat{s}}_{2} = {arg min}_{{s}_{1}^{′} ∈ {𝒮}_{{M}_{1} - NUC}^{{L}_{1}} , {s}_{2}^{′} ∈ {e}^{j θ} {𝒮}_{{M}_{2} - NUC}^{{L}_{2}}} {‖ z - \sum {W}_{2} {s}^{′} ‖}_{2}$$

where the vector z=[z₁z₂]^{T}, the vector s′=[s′₁s′₂]^{T}, the matrix Σ is a 2×2 diagonal matrix with its first diagonal entry equal to σ₁ and its second diagonal entry equal to σ₂, and W₂ is the 2×2 Walsh-Hadamard matrix.

Because the two transmitted modulation symbols are coupled by the Walsh-Hadamard matrix at the transmitter, they may be jointly decoded at the receiver. The receiver may account for the fact that one of the transmitted modulation symbols (in this case, modulation symbol s₂) is from a rotated constellation. In the case where the constellation corresponding to the first eigen-channel is rotated, then decoding of the first modulation symbol may be performed by the receiver with respect to the rotated constellation e^{jθ} S^{L}^{₁}, and decoding of the second modulation symbol may be performed by the receiver with respect to the un-rotated constellation S^{L}^{₂}.

With conventional eigen-beamforming where the multi-layer precoding scheme is not employed, the receiver may decode the received symbols separately. That is, the receiver may obtain ŝ₁ and ŝ₂, the estimates of the transmitted modulation symbols s₁ and s₂, respectively, through two separate operations as shown below:

$${\hat{s}}_{1} = {argmin}_{{s}_{1}^{′} ∈ {𝒮}_{{M}_{1} - NUC}^{{L}_{1}}} ‖ {z}_{1} - {σ}_{1} {s}_{1}^{′} ‖$$

and

$${\hat{s}}_{2} = {argmin}_{{s}_{2}^{′} ∈ {e}^{j θ} {𝒮}_{{M}_{2} - NUC}^{{L}_{2}}} ‖ {z}_{2} - {σ}_{2} {s}_{2}^{′} ‖$$

When

$${𝒮}_{{M}_{1} - NUC}^{{L}_{1}} ⋂ {𝒮}_{{M}_{2} - NUC}^{{L}_{2}} = ∅$$

(when the first

$$NUC {𝒮}_{{M}_{1} - NUC}^{{L}_{1}}$$

and the second NUC

$${𝒮}_{{M}_{2} - NUC}^{{L}_{2}}$$

so not have any common modulation symbols), the transmission procedure may be simplified compared to the case where common modulation symbols are present. In this case, there may be no need to rotate any constellation, because the first NUC and the second NUC each comprise distinct modulation symbols. The transmitter may precode the modulation symbols to be transmitted on the layers with the Walsh-Hadamard matrix without performing constellation rotation.

In this scenario, the transmitter selects the modulation symbol s₁ from the constellation

$${𝒮}_{{M}_{1} - NUC}^{{L}_{1}}$$

and the modulation symbol s₂ from the constellation

$${𝒮}_{{M}_{2} - NUC}^{{L}_{2}} ,$$

where

$${𝒮}_{{M}_{1} - NUC}^{{L}_{1}} ⋂ {𝒮}_{{M}_{2} - NUC}^{{L}_{2}} = ∅$$

The symbol vector s=[s₁s₂]^{T}, comprising the modulation symbols to be transmitted on the first MIMO layer and the second MIMO layer, may be pre-multiplied by a 2×2 Walsh-Hadamard matrix W₂ to obtain a precoded symbol vector x=[x₁x₂]^{T}, where:

x=W₂S

The transmitter transmits the precoded modulation symbol x₁ over the first MIMO layer and the precoded modulation symbol x₂ over the second MIMO layer. The received symbols are given by:

z₁=σ₁x₁+n₁

z₂=σ₂×₂+n₂
where σ₁ and σ₂ are the first and the second singular values, respectively, of the MIMO channel.

Upon receiving the precoded symbols transmitted by the transmitter, the receiver jointly decodes the modulation symbols received on both layers with respect to the constellations used at the transmitter. Because none of the constellations are rotated in this case, there may be no need to employ rotated constellations while decoding the transmitted modulation symbols. The estimates of the transmitted modulation symbols s₁ and s₂, denoted by ŝ₁ and ŝ₂, respectively, may be obtained by:

$${\hat{s}}_{1} , {\hat{s}}_{2} = {argmin}_{{s}_{1}^{′} ∈ {𝒮}_{{M}_{1} - NUC}^{{L}_{1}} , {s}_{2}^{′} ∈ {𝒮}_{{M}_{2} - NUC}^{{L}_{2}}} {‖ z - Σ {W}_{2} {s}^{′} ‖}_{2}$$

where the vector z=[z₁z₂]^{T}, the vector s′=[s′₁s′₂]^{T}, the matrix Σ is a 2×2 diagonal matrix with its first diagonal entry equal to σ₁ and its second diagonal entry equal to σ₂, and W₂ is the 2×2 Walsh-Hadamard matrix.

With conventional eigen-beamforming where the multi-layer precoding scheme is not employed, the receiver may decode the received symbols separately. That is, the receiver may obtain ŝ₁ and ŝ₂, the estimates of the transmitted modulation symbols s₁ and s₂, respectively, through two separate operations:

$${\hat{s}}_{1} = {argmin}_{{s}_{1}^{′} ∈ {𝒮}_{{M}_{1} - NUC}^{{L}_{1}}} ‖ {z}_{1} - {σ}_{1} {s}_{1}^{′} ‖$$

and

$${\hat{s}}_{2} = {argmin}_{{s}_{2}^{′} ∈ {𝒮}_{{M}_{2} - NUC}^{{L}_{2}}} ‖ {z}_{2} - {σ}_{2} {s}_{2}^{′} ‖$$

The multi-layer precoding scheme described above for two-layer transmission may be generalized to transmission over N=2^{k} layers, where k is a positive integer. For example, when

$${𝒮}_{{M}_{i} - NUC}^{{L}_{i}} ⋂ {𝒮}_{{M}_{j} - NUC}^{{L}_{j}} = ∅$$

for some i∈{1, . . . , N} and j∈{1, . . . , N} with i≠j (i.e., when some pairs of constellations

$${𝒮}_{{M}_{1} - NUC}^{{L}_{1}} , {𝒮}_{{M}_{2} - NUC}^{{L}_{2}} , … , {𝒮}_{{M}_{N} - NUC}^{{L}_{N}}$$

have one or more common modulation symbols), the following operations may be performed at the transmitter.

The transmitter may rotate N₁ constellations among the N constellations, where 1≤N₁≤N, such that there are no common modulation symbols across all the resulting constellations after rotating the N₁ constellations. In some cases, one of the constellations may be kept intact and the other N−1 constellations may be rotated such that there are no common modulation symbols across all N constellations. In some other cases, all N constellations may be rotated such that there are no common modulation symbols across the rotated constellations. More generally, N₁ constellations among the N constellations may be rotated, where 1≤N1≤N.

The transmitter may form the symbol vector s=[s₁s₂ . . . s_{N}]^{T} to be transmitted, where the modulation symbols are selected from the constellations (rotated or non-rotated) as determined above. The transmitter then precodes (also referred to as pre-multiplying) the symbol vector s by an N×N Walsh-Hadamard matrix W_{N} to obtain a precoded symbol vector x=[x₁x₂ . . . x_{N}]^{T}, where X=W_{N} S. The transmitter transmits each precoded modulation symbol xₖ over layer k, where k=1, . . . , N.

When

$${𝒮}_{{M}_{i} - NUC}^{{L}_{i}} ⋂ {𝒮}_{{M}_{j} - NUC}^{{L}_{j}} = ∅$$

for any i∈{1, . . . , N} and j∈{1, . . . , N} with i≠j (i.e., when any pair of constellations

$${𝒮}_{{M}_{1} - NUC}^{{L}_{1}} , {𝒮}_{{M}_{2} - NUC}^{{L}_{2}} , … , {𝒮}_{{M}_{N} - NUC}^{{L}_{N}}$$

has no common modulation symbols), there may be no need to rotate any of the constellations used for signaling over any of the layers. The transmitter may precode the modulation symbols to be transmitted on the N layers with a Walsh-Hadamard matrix of appropriate size, which is N×N, where N=2^{k} and k is a positive integer. The transmitter forms the symbol vector s=[s₁s₂ . . . s_{N}]^{T}, where the modulation symbols are selected from the constellations determined for each layer. The transmitter precodes the symbol vector s by an N×N Walsh-Hadamard matrix W_{N} to obtain a precoded symbol vector x=[x₁x₂ . . . x_{N}]^{T}, where x=W_{N}s. The transmitter transmits each precoded modulation symbol xₖ over layer k, where k=1, . . . , N.

The multi-layer precoding scheme described above couples modulation symbols transmitted over multiple MIMO layers by pre-multiplying the symbol vector by a unitary matrix. This coupling spreads the information carried by each layer across all layers, such that each element of the precoded symbol vector is a combination of modulation symbols from multiple layers. As a result, modulation symbols transmitted over weaker MIMO layers may benefit from the channel gains of stronger MIMO layers, improving the reliability of data transmission over the weaker layers as described with reference to FIG. 1. When the NUCs used on different MIMO layers share one or more common modulation symbols, constellation rotation may be applied to ensure that no two constellations share common modulation symbols, which facilitates joint decoding at the receiver. The multi-layer precoding scheme does not introduce redundancy and does not demand additional transmission resources such as transmit power, time, or bandwidth. An implementation of the multi-layer precoding scheme in a signaling flow between a transmitting node and a receiving node is described with reference to FIG. 3.

FIG. 3 illustrates an example of a signaling diagram 300 in accordance with aspects of the present disclosure. In some examples, the signaling diagram 300 implements or is implemented by aspects of the wireless communications system 100 and the constellation arrangements 200. For example, the signaling diagram 300 may implement or be implemented by a node 302 and a node 304, which may be examples of the NE 102 and the UE 104 as described with reference to FIG. 1, respectively, or vice versa. For example, the node 302 may be a transmitting node (e.g., a base station, gNB) equipped with multiple transmit antennas, and the node 304 may be a receiving node (e.g., a UE) equipped with multiple receive antennas. In some examples, the node 302 may be a UE and the node 304 may be an NE. Alternative examples of the following may be implemented, where some operations are performed in a different order than described or are not performed. In some cases, operations may include additional features not mentioned below, or further operations may be added.

At 310, the node 302 may determine to apply a multi-layer precoding scheme for data to be transmitted over two or more MIMO layers to the node 304. The first MIMO layer and the second MIMO layer may correspond to eigen-channels of a MIMO channel between the node 302 and the node 304. In some examples, the eigen-channels correspond to singular values of a channel matrix associated with the MIMO channel, as described with reference to FIG. 1. In some cases, the MIMO channel is a near-field LOS MIMO channel, where only the first or first few eigen-channels have significant channel gains and remaining eigen-channels have substantially lower channel gains. The node 302 may determine to apply the multi-layer precoding scheme based on one or more of a CSI report received from the node 304, an indication received from the node 304 or a third node, or a channel condition associated with at least one of the first MIMO layer or the second MIMO layer. In some examples, the indication received from the node 304 may include a recommendation or request to apply the multi-layer precoding scheme, for example based on channel measurements performed by the node 304. In some examples, the indication received from a third node may include a precoding configuration or a recommendation from an NE such as a neighboring NE, a CU, or a core NE that coordinates transmission parameters across multiple nodes. In some examples, the channel condition includes or is an example of a difference in channel quality between the first MIMO layer and the second MIMO layer. For example, the node 302 may determine to apply the multi-layer precoding scheme when a weaker MIMO layer has a channel quality below a threshold or when a ratio of channel gains between a stronger MIMO layer and a weaker MIMO layer exceeds a threshold.

At 312, the node 302 determines whether to rotate one or more NUCs associated with the two or more MIMO layers. The NUCs may be designed through geometric shaping, as described with reference to FIG. 2. In some examples, at least one of the NUCs is a 1D-NUC or a 2D-NUC. The node 302 may determine whether the first NUC corresponding to the first MIMO layer and the second NUC corresponding to the second MIMO layer share one or more common modulation symbols. In some examples, the first NUC and the second NUC have different modulation orders. For example, the first NUC may have a modulation order of 64 and the second NUC may have a modulation order of 16.

When the first NUC and the second NUC share one or more common modulation symbols, the node 302 rotates at least one of the first NUC or the second NUC by a rotation angle such that no modulation symbol in a rotated NUC is the same as any modulation symbol in another NUC. In some examples, rotating a NUC includes multiplying each modulation symbol in the NUC by a factor of the rotation angle, as described with reference to FIG. 2. The node 302 may select the rotation angle such that an intersection of the rotated NUC and the other NUC is an empty set. In some cases, the node 302 may refrain from rotating at least one of the first NUC or the second NUC based on the first NUC and the second NUC each including distinct modulation symbols (e.g., based on the first NUC and the second NUC having no shared modulation symbols in common).

At 314, the node 302 maps a first set of encoded bits to a first set of modulation symbols selected from the first NUC, the first set of encoded bits corresponding to the first MIMO layer. The first set of modulation symbols may be selected from the first NUC as described with reference to FIG. 2.

At 316, the node 302 maps a second set of encoded bits to a second set of modulation symbols selected from the second NUC, the second set of encoded bits corresponding to the second MIMO layer. In some examples, the second NUC is a rotated version of an original NUC, as determined at 312. In some examples, the node 302 maps one or more additional sets of encoded bits corresponding to one or more additional MIMO layers to one or more additional sets of modulation symbols selected from one or more additional NUCs.

At 318, the node 302 generates a precoded symbol vector according to the multi-layer precoding scheme. The multi-layer precoding scheme includes pre-multiplying a symbol vector by a unitary matrix, where the symbol vector includes the first set of modulation symbols and the second set of modulation symbols. In some examples, the symbol vector further includes the one or more additional sets of modulation symbols corresponding to the one or more additional MIMO layers. The unitary matrix may be a Walsh-Hadamard matrix. In some examples, the unitary matrix has dimensions corresponding to a total quantity of MIMO layers over which the precoded symbol vector is to be transmitted. For example, for a two-layer transmission, the unitary matrix may be a 2×2 Walsh-Hadamard matrix, and for a four-layer transmission, the unitary matrix may be a 4×4 Walsh-Hadamard matrix. In some examples, the unitary matrix is pre-configured at the node 302 and the node 304. For example, the unitary matrix may be agreed upon prior to communication such that both the node 302 and the node 304 use the same unitary matrix without dynamic signaling of the matrix identity.

At 320, the node 302 transmits a multi-layer precoding scheme indication to the node 304 prior to transmitting the precoded symbol vector. The multi-layer precoding scheme indication includes one or more parameters to be used by the node 304 in decoding the precoded symbol vector. For example, the multi-layer precoding scheme indication may indicate or otherwise identify the unitary matrix utilized by the node 302. Additionally, or alternatively, the multi-layer precoding scheme indication may indicate or otherwise identify which, if any, of the NUCs are rotated, and/or a rotation angle applied to each rotated NUC. In some examples, the multi-layer precoding scheme indication is transmitted as a precursor to data transmission, for example via downlink control information (DCI) or other control signaling.

At 322, the node 302 transmits, and the node 304 receives, the precoded symbol vector over at least the first MIMO layer and the second MIMO layer. Each element of the precoded symbol vector is a combination of modulation symbols from the first set of modulation symbols and the second set of modulation symbols, such that information from both stronger and weaker MIMO layers is spread across all layers.

At 324, the node 304 jointly decodes the first set of modulation symbols and the second set of modulation symbols based on the multi-layer precoding scheme indication. The node 304 may jointly decode the modulation symbols with respect to the unitary matrix and the first NUC and the second NUC. In some examples, jointly decoding the modulation symbols includes decoding with respect to at least one rotated NUC among the first NUC and the second NUC. The node 304 may use the unitary matrix identified in the multi-layer precoding scheme indication and the NUCs, including any rotation applied, to recover the transmitted modulation symbols from the precoded symbol vector.

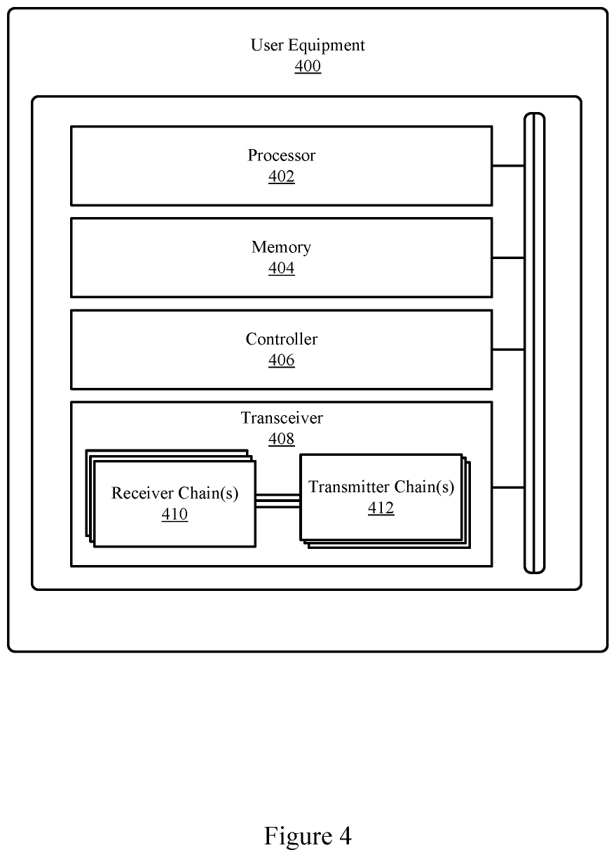

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a central processing unit (CPU), an ASIC, a field-programmable gate-array (FPGA), or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to or operable to support a means for receiving, from a node, an indication of a multi-layer precoding scheme, the multi-layer precoding scheme associated with transmission over at least a first MIMO layer and a second MIMO layer, where the multi-layer precoding scheme includes pre-multiplication of a symbol vector by a unitary matrix, and where the symbol vector includes a first set of modulation symbols selected from a first NUC and a second set of modulation symbols selected from a second NUC; receiving, from the node, a precoded symbol vector over at least the first MIMO layer and the second MIMO layer, the precoded symbol vector generated according to the multi-layer precoding scheme; and jointly decoding the first set of modulation symbols and the second set of modulation symbols based on the indication of the multi-layer precoding scheme. In this manner, the UE 400 supports improved reliability of data reception over weaker MIMO layers by jointly decoding modulation symbols that have been coupled across multiple layers through unitary matrix precoding, enabling spatial multiplexing gain that would otherwise be impractical due to the unreliability of weaker layers.

Additionally, or alternatively, the UE 400 may be configured to support any one or combination of the indication further identifies one or more of the unitary matrix, an identity of at least one rotated NUC, or a rotation angle associated with the at least one rotated NUC. This aspect enables the UE 400 to accurately decode modulation symbols by using the correct unitary matrix and constellation parameters employed at the transmitter, improving decoding accuracy and reducing error rates.

Additionally, or alternatively, the UE 400 may be configured to support any one or combination of jointly decoding the first set of modulation symbols and the second set of modulation symbols includes decoding with respect to the unitary matrix and the first NUC and the second NUC. This aspect ensures that the UE 400 accounts for the coupling of modulation symbols across layers introduced by the unitary matrix, enabling accurate recovery of transmitted symbols from both stronger and weaker MIMO layers.

Additionally, or alternatively, the UE 400 may be configured to support any one or combination of jointly decoding the first set of modulation symbols and the second set of modulation symbols includes decoding with respect to at least one rotated NUC among the first NUC and the second NUC. This aspect enables the UE 400 to correctly decode modulation symbols when constellation rotation has been applied at the transmitter to eliminate common symbols between constellations, facilitating accurate joint decoding.

Additionally, or alternatively, the UE 400 may be configured to support any one or combination of the unitary matrix is a Walsh-Hadamard matrix having dimensions corresponding to a total quantity of MIMO layers over which the precoded symbol vector is received. This aspect provides a structured and computationally efficient approach to joint decoding by using a real-valued unitary matrix with entries of equal magnitude, reducing decoding complexity at the UE 400.

Additionally, or alternatively, the UE 400 may support at least one memory (e.g., the memory 404) and at least one processor (e.g., the processor 402) coupled with the at least one memory and configured to cause the UE 400 to receive, from a node, an indication of a multi-layer precoding scheme, the multi-layer precoding scheme associated with transmission over at least a first MIMO layer and a second MIMO layer, where the multi-layer precoding scheme includes pre-multiplication of a symbol vector by a unitary matrix, and where the symbol vector includes a first set of modulation symbols selected from a first NUC and a second set of modulation symbols selected from a second NUC; receive, from the first node, a precoded symbol vector over at least the first MIMO layer and the second MIMO layer, the precoded symbol vector generated according to the multi-layer precoding scheme; and jointly decode the first set of modulation symbols and the second set of modulation symbols based on the indication of the multi-layer precoding scheme. In this manner, the UE 400 supports improved reliability of data reception over weaker MIMO layers by jointly decoding modulation symbols that have been coupled across multiple layers through unitary matrix precoding, enabling spatial multiplexing gain that would otherwise be impractical due to the unreliability of weaker layers.

Additionally, or alternatively, the UE 400 may be configured to support any one or combination of the indication further identifies one or more of the unitary matrix, an identity of at least one rotated NUC, or a rotation angle associated with the at least one rotated NUC. This aspect enables the UE 400 to accurately decode modulation symbols by using the correct unitary matrix and constellation parameters employed at the transmitter, improving decoding accuracy and reducing error rates.

Additionally, or alternatively, the UE 400 may be configured to support any one or combination of jointly decoding the first set of modulation symbols and the second set of modulation symbols includes decoding with respect to the unitary matrix and the first NUC and the second NUC. This aspect ensures that the UE 400 accounts for the coupling of modulation symbols across layers introduced by the unitary matrix, enabling accurate recovery of transmitted symbols from both stronger and weaker MIMO layers.

Additionally, or alternatively, the UE 400 may be configured to support any one or combination of jointly decoding the first set of modulation symbols and the second set of modulation symbols includes decoding with respect to at least one rotated NUC among the first NUC and the second NUC. This aspect enables the UE 400 to correctly decode modulation symbols when constellation rotation has been applied at the transmitter to eliminate common symbols between constellations, facilitating accurate joint decoding.

Additionally, or alternatively, the UE 400 may be configured to support any one or combination of the unitary matrix is a Walsh-Hadamard matrix having dimensions corresponding to a total quantity of MIMO layers over which the precoded symbol vector is received. This aspect provides a structured and computationally efficient approach to joint decoding by using a real-valued unitary matrix with entries of equal magnitude, reducing decoding complexity at the UE 400.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive a signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

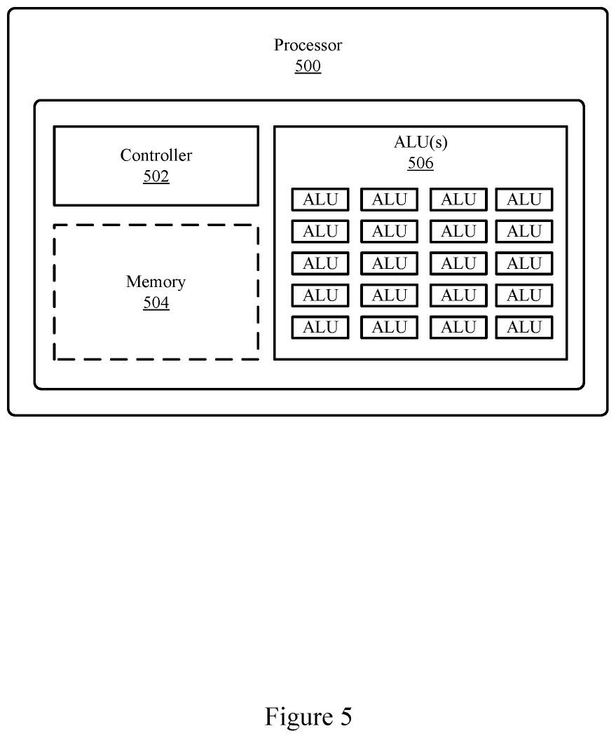

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory addresses of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, ALUs 506, and other functional units of the processor 500.

The memory 504 may include one or more caches (e.g., memory local to or included in the processor 500 or other memory, such as RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, and the controller 502, and may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 may be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support at least one controller (e.g., the controller 502) coupled with at least one memory (e.g., the memory 504) and configured to cause the processor 500 to map a first set of encoded bits to a first set of modulation symbols selected from a first NUC, the first set of encoded bits corresponding to a first MIMO layer, map a second set of encoded bits to a second set of modulation symbols selected from a second NUC, the second set of encoded bits corresponding to a second MIMO layer, generate a precoded symbol vector according to a multi-layer precoding scheme, the multi-layer precoding scheme including pre-multiplying a symbol vector by a unitary matrix, where the symbol vector includes the first set of modulation symbols and the second set of modulation symbols, and transmit, to a second node, the precoded symbol vector over at least the first MIMO layer and the second MIMO layer. In this manner, the processor 500 supports improved reliability of data transmission over weaker MIMO layers by coupling modulation symbols across multiple layers through unitary matrix precoding, enabling spatial multiplexing gain that would otherwise be impractical due to the unreliability of weaker layers.

Additionally, or alternatively, the processor 500 may be configured to support any one or combination of the first NUC and the second NUC share one or more common modulation symbols, and the processor 500 is further configured to rotate at least one of the first NUC or the second NUC by a rotation angle such that no modulation symbol in a rotated NUC is the same as any modulation symbol in another NUC. This aspect ensures that constellations used on different MIMO layers do not share common modulation symbols, facilitating accurate joint decoding at the receiver and improving decoding reliability.

Additionally, or alternatively, the processor 500 may be configured to support any one or combination of rotating the at least one of the first NUC or the second NUC includes multiplying each modulation symbol in the at least one of the first NUC or the second NUC by a factor of the rotation angle. This aspect provides a computationally efficient method for constellation rotation that preserves the geometric properties of the NUC while eliminating common symbols between constellations.

Additionally, or alternatively, the processor 500 may be configured to support any one or combination of selecting the rotation angle such that an intersection of the rotated NUC and the other NUC is an empty set. This aspect ensures complete separation of modulation symbols between constellations used on different layers, enabling unambiguous joint decoding at the receiver. Additionally, or alternatively, the processor 500 may be configured to support any one or combination of refraining from rotating at least one of the first NUC or the second NUC based on the first NUC and the second NUC each including distinct modulation symbols. This aspect reduces computational complexity by avoiding unnecessary constellation rotation when the constellations already comprise distinct modulation symbols.

Additionally, or alternatively, the processor 500 may be configured to support any one or combination of transmitting, to the second node, an indication of the multi-layer precoding scheme prior to transmitting the precoded symbol vector. This aspect enables the receiver to correctly decode the transmitted modulation symbols by providing information about the precoding scheme used at the transmitter. Additionally, or alternatively, the processor 500 may be configured to support any one or combination of the indication identifies one or more of the unitary matrix, an identity of at least one rotated NUC, or a rotation angle applied to the at least one rotated NUC. This aspect provides the receiver with the parameters necessary for accurate joint decoding, including the unitary matrix and any constellation rotation applied at the transmitter.

Additionally, or alternatively, the processor 500 may be configured to support any one or combination of applying the multi-layer precoding scheme based on one or more of a CSI report received from the second node, an indication received from the second node or a third node, or a channel condition associated with at least one of the first MIMO layer or the second MIMO layer. This aspect enables adaptive application of the multi-layer precoding scheme based on channel conditions, improving overall system performance by applying the scheme when it provides the greatest benefit.

Additionally, or alternatively, the processor 500 may be configured to support any one or combination of the unitary matrix is a Walsh-Hadamard matrix. This aspect provides a structured and computationally efficient unitary matrix with real-valued entries of equal magnitude, reducing computational complexity for both precoding at the transmitter and decoding at the receiver. Additionally, or alternatively, the processor 500 may be configured to support any one or combination of the unitary matrix has dimensions corresponding to a total quantity of MIMO layers over which the precoded symbol vector is transmitted. This aspect ensures that the unitary matrix appropriately couples modulation symbols across all MIMO layers used for transmission, enabling information spreading across all layers.

Additionally, or alternatively, the processor 500 may be configured to support any one or combination of the unitary matrix is pre-configured at the first node and the second node. This aspect reduces signaling overhead by using a pre-agreed unitary matrix, eliminating the need for dynamic signaling of the matrix identity. Additionally, or alternatively, the processor 500 may be configured to support any one or combination of the first NUC and the second NUC have different modulation orders. This aspect enables flexible modulation order selection across different MIMO layers, allowing higher modulation orders on stronger layers and lower modulation orders on weaker layers to optimize throughput and reliability. Additionally, or alternatively, the processor 500 may be configured to support any one or combination of a MIMO channel between the first node and the second node is a near-field LoS MIMO channel. This aspect addresses the specific challenge of near-field LoS MIMO channels where only the first or first few eigen-channels have significant channel gains, enabling spatial multiplexing gain that would otherwise be impractical.

Additionally, or alternatively, the processor 500 may be configured to or operable to support at least one controller (e.g., the controller 502) coupled with at least one memory (e.g., the memory 504) and configured to cause the processor 500 to receive, from a first node, an indication of a multi-layer precoding scheme, the multi-layer precoding scheme associated with transmission over at least a first MIMO layer and a second MIMO layer, where the multi-layer precoding scheme includes pre-multiplication of a symbol vector by a unitary matrix, and where the symbol vector includes a first set of modulation symbols selected from a first NUC and a second set of modulation symbols selected from a second NUC, receive, from the first node, a precoded symbol vector over at least the first MIMO layer and the second MIMO layer, the precoded symbol vector generated according to the multi-layer precoding scheme, and jointly decode the first set of modulation symbols and the second set of modulation symbols based on the indication of the multi-layer precoding scheme. In this manner, the processor 500 supports improved reliability of data reception over weaker MIMO layers by jointly decoding modulation symbols that have been coupled across multiple layers through unitary matrix precoding, enabling spatial multiplexing gain that would otherwise be impractical due to the unreliability of weaker layers.

Additionally, or alternatively, the processor 500 may be configured to support any one or combination of the indication further identifies one or more of the unitary matrix, an identity of at least one rotated NUC, or a rotation angle associated with the at least one rotated NUC. This aspect enables the processor 500 to accurately decode modulation symbols by using the correct unitary matrix and constellation parameters employed at the transmitter, improving decoding accuracy and reducing error rates. Additionally, or alternatively, the processor 500 may be configured to support any one or combination of jointly decoding the first set of modulation symbols and the second set of modulation symbols includes decoding with respect to the unitary matrix and the first NUC and the second NUC. This aspect ensures that the processor 500 accounts for the coupling of modulation symbols across layers introduced by the unitary matrix, enabling accurate recovery of transmitted symbols from both stronger and weaker MIMO layers.

Additionally, or alternatively, the processor 500 may be configured to support any one or combination of jointly decoding the first set of modulation symbols and the second set of modulation symbols includes decoding with respect to at least one rotated NUC among the first NUC and the second NUC. This aspect enables the processor 500 to correctly decode modulation symbols when constellation rotation has been applied at the transmitter to eliminate common symbols between constellations, facilitating accurate joint decoding. Additionally, or alternatively, the processor 500 may be configured to support any one or combination of the unitary matrix is a Walsh-Hadamard matrix having dimensions corresponding to a total quantity of MIMO layers over which the precoded symbol vector is received. This aspect provides a structured and computationally efficient approach to joint decoding by using a real-valued unitary matrix with entries of equal magnitude, reducing decoding complexity at the processor 500.

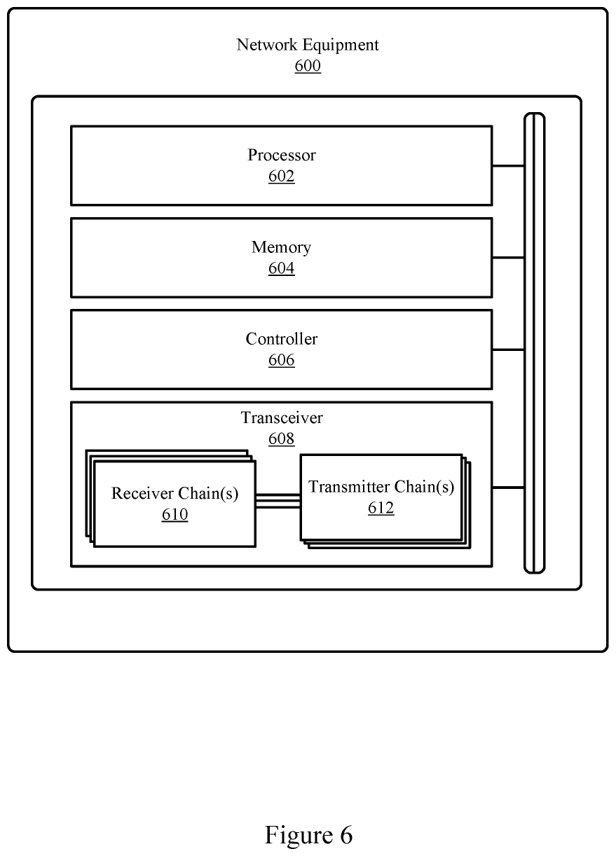

FIG. 6 illustrates an example of an NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to or operable to support a means for mapping a first set of encoded bits to a first set of modulation symbols selected from a first NUC, the first set of encoded bits corresponding to a first MIMO layer, mapping a second set of encoded bits to a second set of modulation symbols selected from a second NUC, the second set of encoded bits corresponding to a second MIMO layer, generating a precoded symbol vector according to a multi-layer precoding scheme, the multi-layer precoding scheme including pre-multiplying a symbol vector by a unitary matrix, where the symbol vector includes the first set of modulation symbols and the second set of modulation symbols, and transmitting, to a second node, the precoded symbol vector over at least the first MIMO layer and the second MIMO layer. In this manner, the NE 600 supports improved reliability of data transmission over weaker MIMO layers by coupling modulation symbols across multiple layers through unitary matrix precoding, enabling spatial multiplexing gain that would otherwise be impractical due to the unreliability of weaker layers.

Additionally, or alternatively, the NE 600 may be configured to support any one or combination of the first NUC and the second NUC share one or more common modulation symbols, and the NE 600 is further configured to rotate at least one of the first NUC or the second NUC by a rotation angle such that no modulation symbol in a rotated NUC is the same as any modulation symbol in another NUC. This aspect ensures that constellations used on different MIMO layers do not share common modulation symbols, facilitating accurate joint decoding at the receiver and improving decoding reliability.

Additionally, or alternatively, the NE 600 may be configured to support any one or combination of rotating the at least one of the first NUC or the second NUC includes multiplying each modulation symbol in the at least one of the first NUC or the second NUC by a factor of the rotation angle. This aspect provides a computationally efficient method for constellation rotation that preserves the geometric properties of the NUC while eliminating common symbols between constellations.

Additionally, or alternatively, the NE 600 may be configured to support any one or combination of selecting the rotation angle such that an intersection of the rotated NUC and the other NUC is an empty set. This aspect ensures complete separation of modulation symbols between constellations used on different layers, enabling unambiguous joint decoding at the receiver. Additionally, or alternatively, the NE 600 may be configured to support any one or combination of refraining from rotating at least one of the first NUC or the second NUC based on the first NUC and the second NUC each including distinct modulation symbols. This aspect reduces computational complexity by avoiding unnecessary constellation rotation when the constellations already include distinct modulation symbols.

Additionally, or alternatively, the NE 600 may be configured to support any one or combination of transmitting, to the second node, an indication of the multi-layer precoding scheme prior to transmitting the precoded symbol vector. This aspect enables the receiver to correctly decode the transmitted modulation symbols by providing information about the precoding scheme used at the transmitter. Additionally, or alternatively, the NE 600 may be configured to support any one or combination of the indication identifies one or more of the unitary matrix, an identity of at least one rotated NUC, or a rotation angle applied to the at least one rotated NUC. This aspect provides the receiver with the parameters necessary for accurate joint decoding, including the unitary matrix and any constellation rotation applied at the transmitter.

Additionally, or alternatively, the NE 600 may be configured to support any one or combination of applying the multi-layer precoding scheme based on one or more of a CSI report received from the second node, an indication received from the second node or a third node, or a channel condition associated with at least one of the first MIMO layer or the second MIMO layer. This aspect enables adaptive application of the multi-layer precoding scheme based on channel conditions, improving overall system performance by applying the scheme when it provides the greatest benefit. Additionally, or alternatively, the NE 600 may be configured to support any one or combination of the unitary matrix is a Walsh-Hadamard matrix. This aspect provides a structured and computationally efficient unitary matrix with real-valued entries of equal magnitude, reducing computational complexity for both precoding at the transmitter and decoding at the receiver.

Additionally, or alternatively, the NE 600 may be configured to support any one or combination of the unitary matrix has dimensions corresponding to a total quantity of MIMO layers over which the precoded symbol vector is transmitted. This aspect ensures that the unitary matrix appropriately couples modulation symbols across all MIMO layers used for transmission, enabling information spreading across all layers. Additionally, or alternatively, the NE 600 may be configured to support any one or combination of the unitary matrix is pre-configured at the first node and the second node. This aspect reduces signaling overhead by using a pre-agreed unitary matrix, eliminating the need for dynamic signaling of the matrix identity.

Additionally, or alternatively, the NE 600 may be configured to support any one or combination of the first NUC and the second NUC have different modulation orders. This aspect enables flexible modulation order selection across different MIMO layers, allowing higher modulation orders on stronger layers and lower modulation orders on weaker layers to optimize throughput and reliability. Additionally, or alternatively, the NE 600 may be configured to support any one or combination of a MIMO channel between the first node and the second node is a near-field LoS MIMO channel. This aspect addresses the specific challenge of near-field LoS MIMO channels where only the first or first few eigen-channels have significant channel gains, enabling spatial multiplexing gain that would otherwise be impractical.

Additionally, or alternatively, the NE 600 may support at least one memory (e.g., the memory 604) and at least one processor (e.g., the processor 602) coupled with the at least one memory and configured to cause the NE 600 to map a first set of encoded bits to a first set of modulation symbols selected from a first NUC, the first set of encoded bits corresponding to a first MIMO layer, map a second set of encoded bits to a second set of modulation symbols selected from a second NUC, the second set of encoded bits corresponding to a second MIMO layer, generate a precoded symbol vector according to a multi-layer precoding scheme, the multi-layer precoding scheme including pre-multiplying a symbol vector by a unitary matrix, where the symbol vector includes the first set of modulation symbols and the second set of modulation symbols, and transmit, to a second node, the precoded symbol vector over at least the first MIMO layer and the second MIMO layer. In this manner, the NE 600 supports improved reliability of data transmission over weaker MIMO layers by coupling modulation symbols across multiple layers through unitary matrix precoding, enabling spatial multiplexing gain that would otherwise be impractical due to the unreliability of weaker layers.

Additionally, or alternatively, the NE 600 may be configured to support any one or combination of the first NUC and the second NUC share one or more common modulation symbols, and the at least one processor is further configured to cause the NE 600 to rotate at least one of the first NUC or the second NUC by a rotation angle such that no modulation symbol in a rotated NUC is the same as any modulation symbol in another NUC. This aspect ensures that constellations used on different MIMO layers do not share common modulation symbols, facilitating accurate joint decoding at the receiver and improving decoding reliability.

Additionally, or alternatively, the NE 600 may be configured to support any one or combination of rotating the at least one of the first NUC or the second NUC includes multiplying each modulation symbol in the at least one of the first NUC or the second NUC by a factor of the rotation angle. This aspect provides a computationally efficient method for constellation rotation that preserves the geometric properties of the NUC while eliminating common symbols between constellations. Additionally, or alternatively, the NE 600 may be configured to support any one or combination of selecting the rotation angle such that an intersection of the rotated NUC and the other NUC is an empty set. This aspect ensures complete separation of modulation symbols between constellations used on different layers, enabling unambiguous joint decoding at the receiver.

Additionally, or alternatively, the NE 600 may be configured to support any one or combination of refraining from rotating at least one of the first NUC or the second NUC based on the first NUC and the second NUC each including distinct modulation symbols. This aspect reduces computational complexity by avoiding unnecessary constellation rotation when the constellations already include distinct modulation symbols. Additionally, or alternatively, the NE 600 may be configured to support any one or combination of transmitting, to the second node, an indication of the multi-layer precoding scheme prior to transmitting the precoded symbol vector. This aspect enables the receiver to correctly decode the transmitted modulation symbols by providing information about the precoding scheme used at the transmitter.

Additionally, or alternatively, the NE 600 may be configured to support any one or combination of the indication identifies one or more of the unitary matrix, an identity of at least one rotated NUC, or a rotation angle applied to the at least one rotated NUC. This aspect provides the receiver with the parameters necessary for accurate joint decoding, including the unitary matrix and any constellation rotation applied at the transmitter. Additionally, or alternatively, the NE 600 may be configured to support any one or combination of applying the multi-layer precoding scheme based on one or more of a CSI report received from the second node, an indication received from the second node or a third node, or a channel condition associated with at least one of the first MIMO layer or the second MIMO layer. This aspect enables adaptive application of the multi-layer precoding scheme based on channel conditions, improving overall system performance by applying the scheme when it provides the greatest benefit.

Additionally, or alternatively, the NE 600 may be configured to support any one or combination of the unitary matrix is a Walsh-Hadamard matrix. This aspect provides a structured and computationally efficient unitary matrix with real-valued entries of equal magnitude, reducing computational complexity for both precoding at the transmitter and decoding at the receiver. Additionally, or alternatively, the NE 600 may be configured to support any one or combination of the unitary matrix has dimensions corresponding to a total quantity of MIMO layers over which the precoded symbol vector is transmitted. This aspect ensures that the unitary matrix appropriately couples modulation symbols across all MIMO layers used for transmission, enabling information spreading across all layers.

Additionally, or alternatively, the NE 600 may be configured to support any one or combination of the unitary matrix is pre-configured at the first node and the second node. This aspect reduces signaling overhead by using a pre-agreed unitary matrix, eliminating the need for dynamic signaling of the matrix identity. Additionally, or alternatively, the NE 600 may be configured to support any one or combination of the first NUC and the second NUC have different modulation orders. This aspect enables flexible modulation order selection across different MIMO layers, allowing higher modulation orders on stronger layers and lower modulation orders on weaker layers to optimize throughput and reliability. Additionally, or alternatively, the NE 600 may be configured to support any one or combination of a MIMO channel between the first node and the second node is a near-field LoS MIMO channel. This aspect addresses the specific challenge of near-field LoS MIMO channels where only the first or first few eigen-channels have significant channel gains, enabling spatial multiplexing gain that would otherwise be impractical.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., an LNA) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

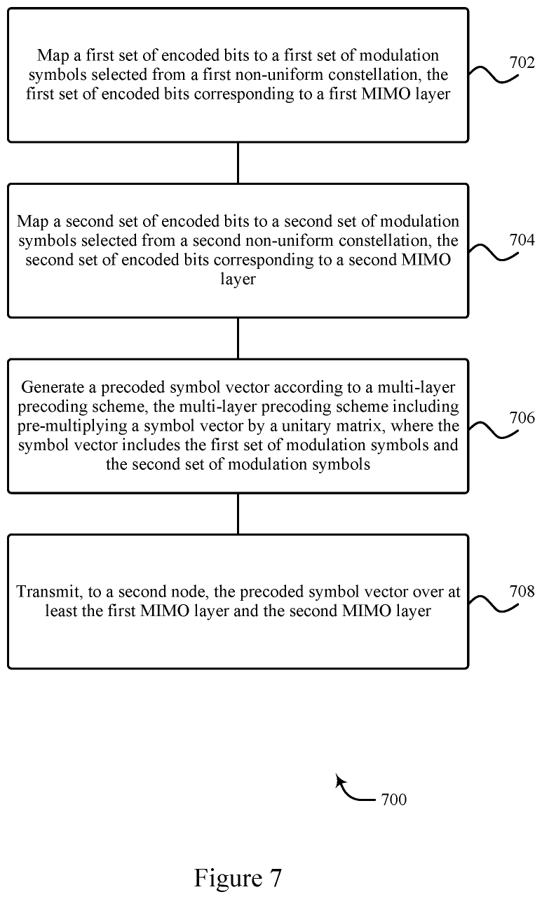

FIG. 7 illustrates a flowchart of a method 700 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 702, the method may include mapping a first set of encoded bits to a first set of modulation symbols selected from a first NUC, the first set of encoded bits corresponding to a first MIMO layer. The operations of 702 may be performed in accordance with examples as described herein. In some implementations, aspects of the operations of 702 may be performed by an NE as described with reference to FIG. 6.

At 704, the method may include mapping a second set of encoded bits to a second set of modulation symbols selected from a second NUC, the second set of encoded bits corresponding to a second MIMO layer. The operations of 704 may be performed in accordance with examples as described herein. In some implementations, aspects of the operations of 704 may be performed by an NE as described with reference to FIG. 6.

At 706, the method may include generating a precoded symbol vector according to a multi-layer precoding scheme, the multi-layer precoding scheme including pre-multiplying a symbol vector by a unitary matrix, where the symbol vector includes the first set of modulation symbols and the second set of modulation symbols. The operations of 706 may be performed in accordance with examples as described herein. In some implementations, aspects of the operations of 706 may be performed by an NE as described with reference to FIG. 6.

At 708, the method may include transmitting, to a second node, the precoded symbol vector over at least the first MIMO layer and the second MIMO layer. The operations of 708 may be performed in accordance with examples as described herein. In some implementations, aspects of the operations of 708 may be performed by an NE as described with reference to FIG. 6.

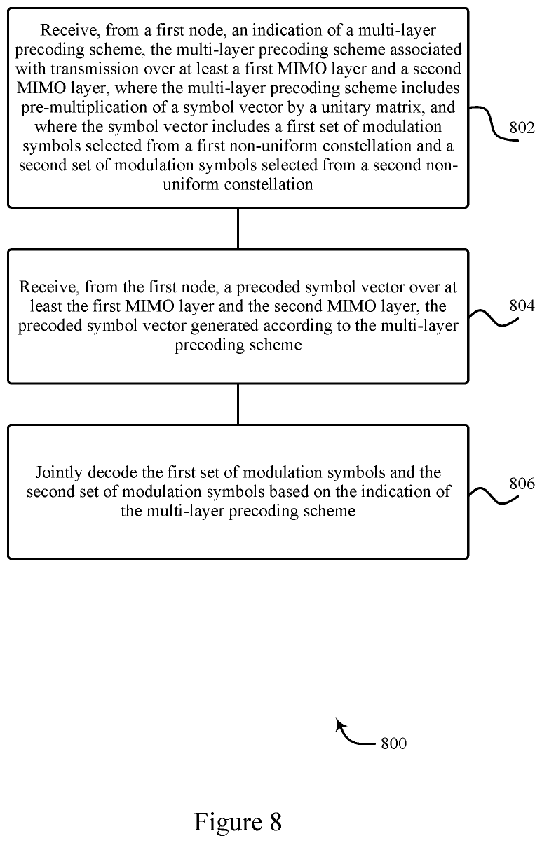

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include receiving, from a first node, an indication of a multi-layer precoding scheme, the multi-layer precoding scheme associated with transmission over at least a first MIMO layer and a second MIMO layer, where the multi-layer precoding scheme includes pre-multiplication of a symbol vector by a unitary matrix, and where the symbol vector includes a first set of modulation symbols selected from a first NUC and a second set of modulation symbols selected from a second NUC. The operations of 802 may be performed in accordance with examples as described herein. In some implementations, aspects of the operations of 802 may be performed by a UE as described with reference to FIG. 4.

At 804, the method may include receiving, from the first node, a precoded symbol vector over at least the first MIMO layer and the second MIMO layer, the precoded symbol vector generated according to the multi-layer precoding scheme. The operations of 804 may be performed in accordance with examples as described herein. In some implementations, aspects of the operations of 804 may be performed by a UE as described with reference to FIG. 4.

At 806, the method may include jointly decoding the first set of modulation symbols and the second set of modulation symbols based at least in part on the indication of the multi-layer precoding scheme. The operations of 806 may be performed in accordance with examples as described herein. In some implementations, aspects of the operations of 806 may be performed by a UE as described with reference to FIG. 4.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first node for wireless communication, comprising:
at least one memory; and
at least one processor coupled with the at least one memory and operable to cause the first node to:
map a first set of encoded bits to a first set of modulation symbols selected from a first non-uniform constellation, the first set of encoded bits corresponding to a first multiple-input multiple-output (MIMO) layer;
map a second set of encoded bits to a second set of modulation symbols selected from a second non-uniform constellation, the second set of encoded bits corresponding to a second MIMO layer;
generate a precoded symbol vector according to a multi-layer precoding scheme, the multi-layer precoding scheme including pre-multiplying a symbol vector by a unitary matrix, wherein the symbol vector includes the first set of modulation symbols and the second set of modulation symbols; and
transmit, to a second node, the precoded symbol vector over at least the first MIMO layer and the second MIMO layer.

2. The first node of claim 1, wherein the first non-uniform constellation and the second non-uniform constellation share one or more common symbols, and wherein the at least one processor is further operable to cause the first node to rotate at least one of the first non-uniform constellation or the second non-uniform constellation by a rotation angle such that no symbol in a rotated non-uniform constellation is the same as any symbol in another non-uniform constellation.

3. The first node of claim 2, wherein, to rotate the at least one of the first non-uniform constellation or the second non-uniform constellation, the at least one processor is operable to cause the first node to multiply each symbol in the at least one of the first non-uniform constellation or the second non-uniform constellation by a factor of the rotation angle.

4. The first node of claim 2, wherein the at least one processor is further operable to cause the first node to select the rotation angle such that an intersection of the rotated non-uniform constellation and the other non-uniform constellation is an empty set.

5. The first node of claim 1, wherein the at least one processor is further operable to cause the first node to transmit, to the second node, an indication of the multi-layer precoding scheme prior to transmitting the precoded symbol vector.

6. The first node of claim 5, wherein the indication identifies one or more of the unitary matrix, an identity of at least one rotated non-uniform constellation, or a rotation angle applied to the at least one rotated non-uniform constellation.

7. The first node of claim 1, wherein the at least one processor is further operable to cause the first node to apply the multi-layer precoding scheme based at least in part on one or more of a channel state information (CSI) report received from the second node, an indication received from the second node or a third node, or a channel condition associated with at least one of the first MIMO layer or the second MIMO layer.

8. The first node of claim 1, wherein the unitary matrix is a Walsh-Hadamard matrix.

9. The first node of claim 1, wherein the unitary matrix has dimensions corresponding to a total quantity of MIMO layers over which the precoded symbol vector is transmitted.

10. The first node of claim 1, wherein the unitary matrix is pre-configured at the first node and the second node.

11. The first node of claim 1, wherein the first non-uniform constellation and the second non-uniform constellation have different modulation orders.

12. The first node of claim 1, wherein a MIMO channel between the first node and the second node is a near-field line-of-sight (LoS) MIMO channel.

13. A second node for wireless communication, comprising:
at least one memory; and
at least one processor coupled with the at least one memory and operable to cause the second node to:
receive, from a first node, an indication of a multi-layer precoding scheme, the multi-layer precoding scheme associated with transmission over at least a first multiple-input multiple-output (MIMO) layer and a second MIMO layer, wherein the multi-layer precoding scheme includes pre-multiplication of a symbol vector by a unitary matrix, and wherein the symbol vector includes a first set of modulation symbols selected from a first non-uniform constellation and a second set of modulation symbols selected from a second non-uniform constellation;
receive, from the first node, a precoded symbol vector over at least the first MIMO layer and the second MIMO layer, the precoded symbol vector generated according to the multi-layer precoding scheme; and
jointly decode the first set of modulation symbols and the second set of modulation symbols based at least in part on the indication of the multi-layer precoding scheme.

14. The second node of claim 13, wherein the indication further identifies one or more of the unitary matrix, an identity of at least one rotated non-uniform constellation, or a rotation angle associated with the at least one rotated non-uniform constellation.

15. The second node of claim 13, wherein jointly decoding the first set of modulation symbols and the second set of modulation symbols comprises decoding with respect to the unitary matrix and the first non-uniform constellation and the second non-uniform constellation.

16. The second node of claim 13, wherein jointly decoding the first set of modulation symbols and the second set of modulation symbols comprises decoding with respect to at least one rotated non-uniform constellation among the first non-uniform constellation and the second non-uniform constellation.

17. The second node of claim 13, wherein the unitary matrix is a Walsh-Hadamard matrix having dimensions corresponding to a total quantity of MIMO layers over which the precoded symbol vector is received.

18. A method performed by a first node, the method comprising:
mapping a first set of encoded bits to a first set of modulation symbols selected from a first non-uniform constellation, the first set of encoded bits corresponding to a first multiple-input multiple-output (MIMO) layer;
mapping a second set of encoded bits to a second set of modulation symbols selected from a second non-uniform constellation, the second set of encoded bits corresponding to a second MIMO layer;
generating a precoded symbol vector according to a multi-layer precoding scheme, the multi-layer precoding scheme including pre-multiplying a symbol vector by a unitary matrix, wherein the symbol vector includes the first set of modulation symbols and the second set of modulation symbols; and
transmitting, to a second node, the precoded symbol vector over at least the first MIMO layer and the second MIMO layer.

19. The method of claim 18, wherein the first non-uniform constellation and the second non-uniform constellation share one or more common modulation symbols, the method further comprising rotating at least one of the first non-uniform constellation or the second non-uniform constellation by a rotation angle such that no modulation symbol in a rotated non-uniform constellation is the same as any modulation symbol in another non-uniform constellation.

20. A method performed by a second node, the method comprising:
receiving, from a first node, an indication of a multi-layer precoding scheme, the multi-layer precoding scheme associated with transmission over at least a first multiple-input multiple-output (MIMO) layer and a second MIMO layer, wherein the multi-layer precoding scheme includes multiplication of a symbol vector by a unitary matrix, and wherein the symbol vector includes a first set of modulation symbols selected from a first non-uniform constellation and a second set of modulation symbols selected from a second non-uniform constellation;
receiving, from the first node, a precoded symbol vector over at least the first MIMO layer and the second MIMO layer, the precoded symbol vector generated according to the multi-layer precoding scheme; and
jointly decoding the first set of modulation symbols and the second set of modulation symbols based at least in part on the indication of the multi-layer precoding scheme.
